(19) United States
(12) Patent Application Publication
(10) Pub. No.: US 2001/0054363 A1
(43) Pub. Date: Dec. 27, 2001

(54) Computer-to-cylinder recording type lithographic printing method and computer-to-cylinder recording type lithographic printing apparatus

(76) Inventors: Yusuke Nakazawa, Shizuoka (JP); Hideyuki Koguchi, Kanagawa (JP); Kazuo Ishii, Shizuoka (JP); Eiichi Kato, Shizuoka (JP)

Correspondence Address: SUGHRUE, MION, ZINN, MACPEAK & SEAS, PLLC, 2100 Pennsylvania Avenue, N.W., Washington, DC, 20037, US

(21) Appl. No.: 09/855,800

(22) Filed: May 16, 2001

(30) Foreign Application Priority Data
May 16, 2000 (JP) P. 2000-143385
May 25, 2000 (JP) P 2000-154837

(51) Int. Cl. B41N 1/10

(52) U.S. Cl. 101/465

(57) ABSTRACT

A computer-to-cylinder recording type lithographic printing method comprising: mounting a printing plate precursor onto a plate cylinder; forming an image directly onto a surface of said printing plate precursor mounted on the plate cylinder, by an ink jet process which comprises ejecting an ink containing a lipophilic component onto said printing plate precursor surface from a recording head having a plurality of ejection channels according to signals of image data, to thereby prepare a printing plate, said image recording being carried out while rotating the plate cylinder to effect main scanning, and moving said recording head in a direction parallel to an axis of the plate cylinder to effect subsidiary scanning; and performing lithographic printing with said printing plate, wherein the number of the ejection channels of said recording head is (X·(N/K)+1) and wherein the subsidiary scanning movement of said ejection head is carried out continuously at a constant speed of (X·(N/K)+1) (dot/rotation). The symbols X, N and K are defined in the specification.

### FIELD OF THE INVENTION

The present invention relates to a computer-to-cylinder lithographic printing method involving digital plate-making on a press and a computer-to-cylinder lithographic printing apparatus therefor (hereinafter simply referred to as “lithographic printing method” and “lithographic printing apparatus”, respectively). More particularly, the present invention relates to a lithographic printing method which comprises performing plate-making with an ink containing a lipophilic component by an ink jet process, followed by printing, whereby a large number of sheets of sharp printed matter having a high quality can be obtained, and a lithographic printing apparatus therefor.

### BACKGROUND OF THE INVENTION

In the art of lithographic printing, ink receptive areas and ink repellent areas are formed on a surface of a printing plate in accordance with an original image. Printing ink adheres to the ink receptive areas to effect printing. Ordinarily, hydrophilic areas and lipophilic (ink receptive) areas are formed imagewise on the surface of a printing plate, and the hydrophilic areas are converted to ink repellent areas by applying dampening water thereto.

Conventional image recording (plate-making) on a printing plate precursor is carried out by exposing a silver salt photographic film with the desired image in an analog or digital manner, exposing a photopolymer material containing a diazo resin or a photopolymerizable polymer (printing plate precursor) to light through the silver halide photographic film, and then dissolving out the non-image areas mostly with an alkaline solution.

With recent improvements in digital recording technology and the demand for more efficient printing processes, various methods where digital image information is directly recorded on a printing plate precursor have been proposed in the field of lithographic printing method. These methods include technologies referred to a CTP (computer-to-plate) and a DDPP (digital direct printing plate) method, These methods typically involve an image recording system having a photon mode or heating mode using a laser beam. Some of these methods have been put to practical use.

However, after the image is recorded on a plate using either the photon mode or the heating mode, the non-image areas are dissolved out by treating the plate with an alkaline developer, resulting in the discharge of an alkaline waste liquid, which is environmentally undesirable.

JP-A-64-27953 (The term “J?-A” as used herein means an “unexamined published Japanese patent application”) discloses a plate-making method which comprises recording an image of a lipophilic wax ink on a hydrophilic printing plate precursor by an ink jet recording process. However, this method is disadvantageous in that since the image is formed of a wax, the resulting image area has a reduced mechanical strength. This method is also disadvantageous in that the adhesion of the image area to the hydrophilic surface of the printing plate precursor is insufficient, reducing the press life.

Further, JP-A-11-70632 discloses a plate-making method which comprises recording an image of an aqueous solution or aqueous colloidal dispersion of a hydrophobic organic acid salt on a hydrophilic printing plate precursor by an ink jet recording process.

However, these methods are disadvantageous in that the printing plate obtained by plate-making needs to be manually mounted on the plate cylinder of an offset press, requiring much time to set the press and causing shear in printing of a plurality of colors.

As a means of effecting the printing process at an enhanced efficiency there is proposed a system in which image recording is effected on the press. JP-A-4-97848 discloses a method which comprises forming a lipophilic or hydrophilic image on a plate drum which is hydrophilic or lipophilic on the surface thereof instead of the conventional plate cylinder by an ink jet process, and then removing the image after printing to clean the plate drum. However, this method is disadvantageous in that the desired removability of printed image (i.e., cleanability) and press life cannot be accomplished at the same time. In order to form a printed image having a prolonged press life on the plate cylinder, it is necessary that an ink containing a resin in a relatively high concentration be used. Thus, the ink jet recording means for forming a printed image uses a resin solution as an ink. Accordingly, the resin can be easily solidified due to the evaporation of solvent at the nozzle, deteriorating the stability in the ejection of ink. As a result, a good image can hardly be obtained.

### SUMMARY OF THE INVENTION

The present invention has been worked out paying attention to the foregoing problems. It is therefore an object of the present invention is to provide a lithographic printing method and apparatus for use with a digital recording system requiring no development.

It is another object of the present invention is to provide a lithographic printing method and apparatus capable of providing a large number of prints having sharp images of high quality in a simple and inexpensive manner.

Other objects and effects of the present invention will become apparent from the following detailed description and examples.

The foregoing objects of the present invention have been achieved by providing the following lithographic printing methods and lithographic printing apparatuses. 1) A computer-to-cylinder recording type lithographic printing method comprising:

mounting a printing plate precursor onto a plate cylinder;

forming an image directly onto a surface of said printing plate precursor mounted on the plate cylinder, by an ink jet process which comprises ejecting an ink containing a lipophilic component onto said printing plate precursor surface from a recording head having a plurality of ejection channels according to signals of image data, to thereby prepare a printing plate, said image recording being carried out while rotating the plate cylinder to effect main scanning, and moving said recording head in a direction parallel to an axis of the plate cylinder to effect subsidiary scanning; and

performing lithographic printing with said printing plate,

wherein the number of the ejection channels of said recording head to be used for the image formation is (X·(N/K)+1), wherein N (dots/25.4 mm) represents an image recording resolution on the printing plate precursor in a direction perpendicular to the rotation of said plate cylinder; K (dots/25.4 mm) represents the density of channels in the ejection head in the direction perpendicular to the rotation of said plate cylinder; and X represents an arbitrary positive integer, and wherein the subsidiary scanning movement of said ejection head is carried out continuously at a constant speed of (X·(N/K)+1) (dot/rotation).

2) The computer-to-cylinder recording type lithographic printing method according to item 1) above, further comprising removing dust present on the surface of said printing plate precursor at least one of before and during said image recording.

3) The computer-to-cylinder recording type lithographic printing method according to item 1) above, further comprising cleaning said recording head at least after the termination of the printing plate preparation.

4) The computer-to-cylinder recording type lithographic printing method according to item 1) above, wherein said ejection of the ink from said recording head is carried out utilizing an electrostatic field.

5) The computer-to-cylinder recording type lithographic printing method according to item 4) above, wherein said ink comprises:

a nonaqueous solvent having an electrical specific resistance of 10⁹ Ω-cm or more and a dielectric constant of 3.5 or less; and

resin particles dispersed therein, which are solid and hydrophobic at least at ordinary temperature.

6) A computer-to-cylinder recording type lithographic printing apparatus comprising:

a plate cylinder for mounting a printing plate precursor thereon;

an image forming unit comprising an ink jet recording device including a recording head having a plurality of ejection channels, which ink jet recording device forms an image by ejecting an ink containing a lipophilic component from said recording head directly onto a surface of the printing plate precursor mounted on said plate cylinder according to signals of image data utilizing an electrostatic field to prepare a printing plate; and

a lithographic printing unit which performs lithographic printing with the printing plate formed by said image forming unit,

wherein said image forming unit performs main scanning by rotating said plate cylinder mounting the printing plate precursor thereon and performs subsidiary scanning by moving said recording head in a direction parallel to an axis of the plate cylinder,

wherein the number of the ejection channels of said recording head to be used for the image formation is (X·(N/K)+1), wherein N (dots/25.4 mm) represents an image recording resolution on the printing plate precursor in a direction perpendicular to the rotation of said plate cylinder; K (dots/25.4 mm) represents the density of channels in the ejection head in the direction perpendicular to the rotation of said plate cylinder; and X represents an arbitrary positive integer, and wherein the subsidiary scanning movement of said ejection head is carried out continuously at a constant speed of (X·(N/K)+1) (dot/rotation).

7) The computer-to-cylinder recording type lithographic printing apparatus according to item 6) above, wherein said image forming unit further comprises a dust removing member which removes dust present on the surface of the printing plate precursor at least one of before and during the image recording.

8) The computer-to-cylinder recording type lithographic printing apparatus according to item 6) above, wherein said ink jet recording device further comprises a recording head moving member which moves said recording head close to said plate cylinder during the image recording and moving said recording head away from said plate cylinder except during the image recording.

9) The computer-to-cylinder recording type lithographic printing apparatus according to item 6) above, wherein said image forming unit further comprises a recording head cleaning member which cleans the recording head at least after the termination of the printing plate preparation.

10) The computer-to-cylinder recording type lithographic printing apparatus according to item 6) above, wherein said lithographic printing unit further comprises a paper dust removing member which removes paper dust during the lithographic printing.

11) The computer-to-cylinder recording type lithographic printing apparatus according to item 6) above, wherein said ink jet recording device further comprises means for ejecting the ink from said recording head utilizing an electrostatic field.

12) The computer-to-cylinder recording type lithographic printing apparatus according to item 11) above, wherein said ink comprises:

a nonaqueous solvent having an electrical specific resistance of 10⁹ Ω-cm or more and a dielectric constant of 3.5 or less; and

resin particles dispersed therein, which are solid and hydrophobic at least at ordinary temperature.

13) The computer-to-cylinder recording type lithographic printing apparatus according to item 6) above, wherein said image forming unit further comprises an ink-fixing unit.

14) The computer-to-cylinder recording type lithographic printing apparatus according to item 6) above, wherein said ink jet recording device further comprises an ink supplying member which supplies the ink to said recording head.

15) The computer-to-cylinder recording type lithographic printing apparatus according to item 14) above, wherein said ink jet recording device further comprises an ink-recovering member which recovers the ink from the recording head to circulate the ink together with said ink-supplying member.

16) The computer-to-cylinder recording type lithographic printing apparatus according to item 14) above, wherein said ink jet recording device further comprises an ink tank for storing the ink and an ink stirring member which stirs the ink in said ink tank.

17) The computer-to-cylinder recording type lithographic printing apparatus according to item 6) above, wherein said ink jet recording device further comprises an ink tank for storing the ink and an ink temperature controlling member provided in said ink tank.

18) The computer-to-cylinder recording type lithographic printing apparatus according to item 6) above, wherein said ink jet recording device further comprises an ink concentration controlling member which controls a concentration of the ink.

19) The computer-to-cylinder recording type lithographic printing apparatus according to item 6) above, wherein said image forming unit further comprises a recording head temperature controlling member which controls a temperature of said recording head.

As mentioned above, the lithographic printing method according to the invention involves an ink jet process which comprises ejecting an ink containing a lipophilic component onto a printing plate precursor mounted on the plate cylinder of a press from a recording head (hereinafter also referred to as “ejection head”) having a plurality of ejection channels according to signals of image data while rotating the plate cylinder to effect main scanning, whereby an image is recorded while moving the recording head in the direction parallel to the axis of the plate cylinder to effect subsidiary scanning, making it possible to form a printing plate having a high image quality corresponding to the digital image data directly on the press in a stable manner and hence obtain a large number of sheets of printed matter of sharp images. Thus, high speed lithographic printing can be made at a reduced cost.

### BRIEF DESCRIPTION OF THE DRAWINGS

By way of example and to make the description more clear, reference is made to the accompanying drawings in which:

FIG. 1 is an overall schematic diagram illustrating an embodiment of the computer-to-cylinder recording type monochromatic lithographic printing apparatus according to the invention;

FIG. 2 is a schematic diagram illustrating an embodiment of the recording portion of the computer-to-cylinder recording type lithographic printing apparatus according to the invention;

FIG. 3 is a first diagram illustrating the subsidiary scanning control used in the present invention;

FIG. 4 is a second diagram (ordinary type) illustrating the subsidiary scanning control used in the present invention;

FIG. 5 is a schematic diagram illustrating an embodiment of the head provided in the ink jet recording apparatus used in the present invention;

FIG. 6 is a schematic sectional view of a portion in the vicinity of the ink ejection portion of FIG. 5;

FIG. 7 is a schematic sectional view of a portion in the vicinity of the ink ejection portion in another embodiment of the head provided in the ink jet recording apparatus used in the present invention;

FIG. 8 is a schematic front view of a portion in the vicinity of the ink ejection portion of FIG. 7;

FIG. 9 is a schematic diagram of an essential part of another embodiment of the head provided in the ink jet recording apparatus used in the present invention;

FIG. 10 is a schematic diagram of the head of FIG. 9 excluding the regulating plate;

FIG. 11 is a schematic diagram of an essential part of other embodiment of the head provided in the ink jet recording apparatus used in the present invention;

FIG. 12 is an overall schematic diagram illustrating a computer-to-cylinder recording type four-color one-sided lithographic printing apparatus as an embodiment of the color printing machine according to the present invention;

FIG. 13 is an overall schematic diagram illustrating another embodiment of the computer-to-cylinder recording type monochromatic lithographic printing apparatus according to the invention;

FIG. 14 is an overall schematic diagram illustrating a further embodiment of the computer-to-cylinder recording type monochromatic lithographic printing apparatus according to the invention; and

FIG. 15 is a schematic diagram illustrating an embodiment of the head protective cover used in the invention.

### DETAILED DESCRIPTION OF THE INVENTION

Embodiments for carrying out the present invention will be described in detail hereinafter.

The present invention has a feature that an image if formed on a printing plate precursor mounted on the plate cylinder of a press by an ink jet process involving the ejection of an ink containing at least a lipophilic component. As the ink jet process according to the invention there may be used any type of ink jet process which can eject an ink containing a lipophilic component.

To be concrete, a piezoelectric process, a thermal jet process, an electrostatic process and a discharging process as described in references, e.g., “Imaging Part II-Saishin no Kopii Purinta Gijutsu (Modern Hard Copy Printer Technology)”, The Society of Electrophotography of Japan, Chapter 3, Shashin Kogyo Shuppansha, 1988, Hiroshi Kokado, “Kiroku Kioku Gijutsu Handobukku (Handbook of Recording and Storage)”, Maruzen, 1992, may be employed. Further, various combined processes using two or more of the above-enumerated processes (e.g. a process where a liquid droplet is ejected by a piezoelectric process and the flying of the ejected droplet is controlled by an electrostatic process) are also known as disclosed in JP-A-10-175300, JP-A-6-23986, JP-A-5-131633, JP-A-10-114073, JP-A-10-34967, JP-A-3-104650 and JP-A-8-300803. The combined processes can be suitably used in the present invention.

Moreover, an electrostatic ink jet recording process disclosed in PCT WO93/11866 may be used. In this electrostatic ink jet printing method, an oil-based ink having a high resistivity having colored resin particles dispersed in an insulating solvent is used. By allowing a strong electric field to be acted on the ink at the ejection position, aggregates of the colored particles are formed at the ejection position. Further, the aggregates are ejected from the ejection position by an electrostatic device. In this manner, the colored resin particles are ejected in the form of highly concentrated aggregates, making it possible to print dots on a printing medium to a sufficient thickness. Therefore, if resin particles are used instead of the colored particles and a printing plate precursor is used as a printing medium, an image of condensed resin particles having a sufficient press life is formed on the printing plate precursor.

In the ink jet recording method, the size of the ejected ink droplets is determined by the size of the tip of the ejection electrode or the conditions of the formation of electric field, making it possible to form minute ink droplets without reducing the ejection nozzle diameter or the ejection slit width. By controlling the application condition of the applied electric field, the diameter of dots formed on the printing plate precursor can be controlled. Thus, in accordance with the present invention, a large number of prints of clear images can be printed.

As mentioned above, the present invention involves plate making on the press by an ink jet recording process, making it possible to provide a large number of sheets of prints of clear images having a high quality using an inexpensive apparatus and a simple process.

An example of the configuration of press recording type lithographic printing apparatus for use in the implication of the lithographic printing method according to the invention will be described hereinafter.

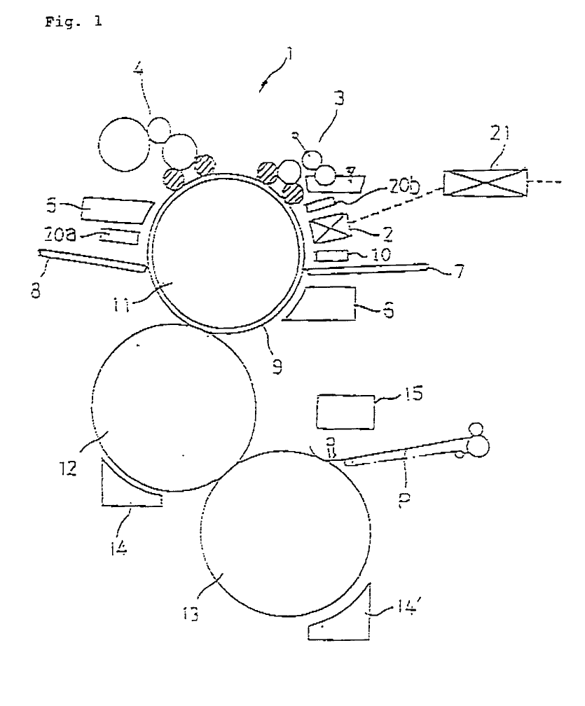

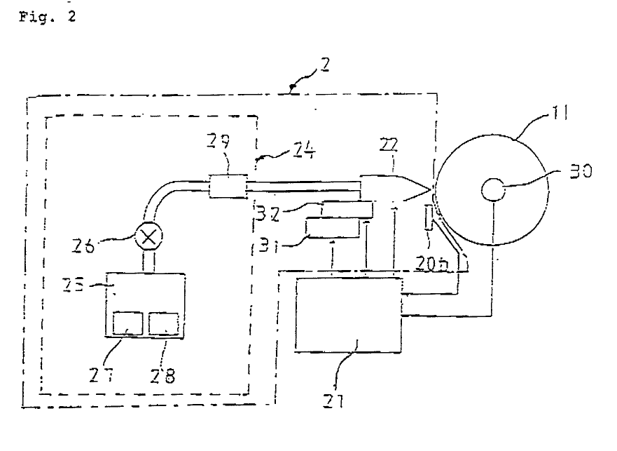

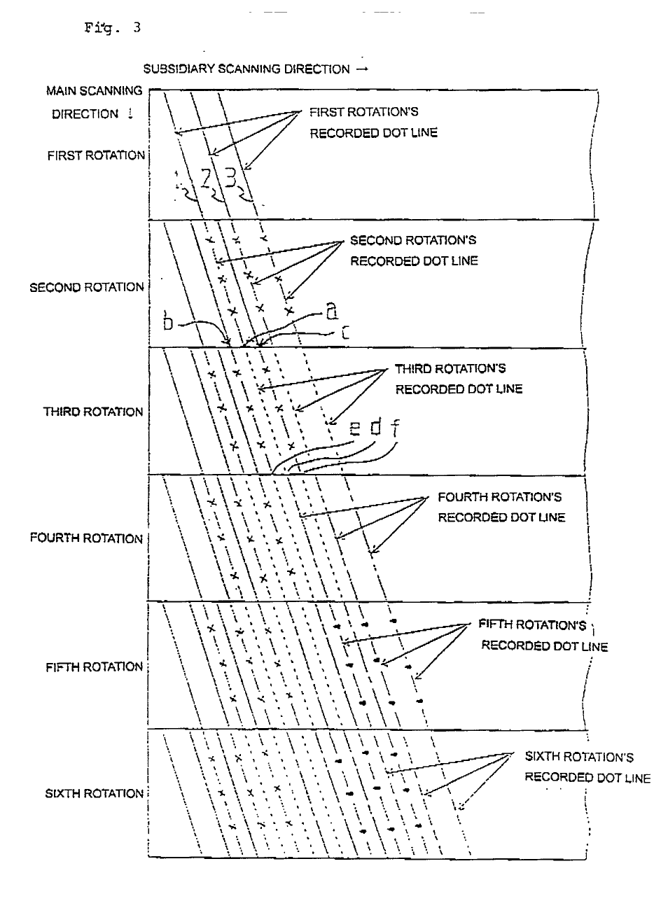

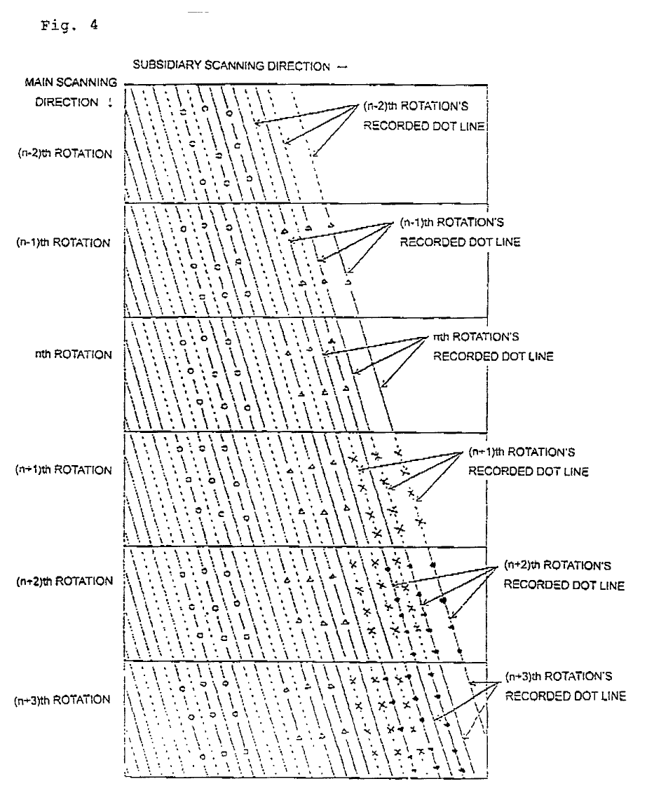

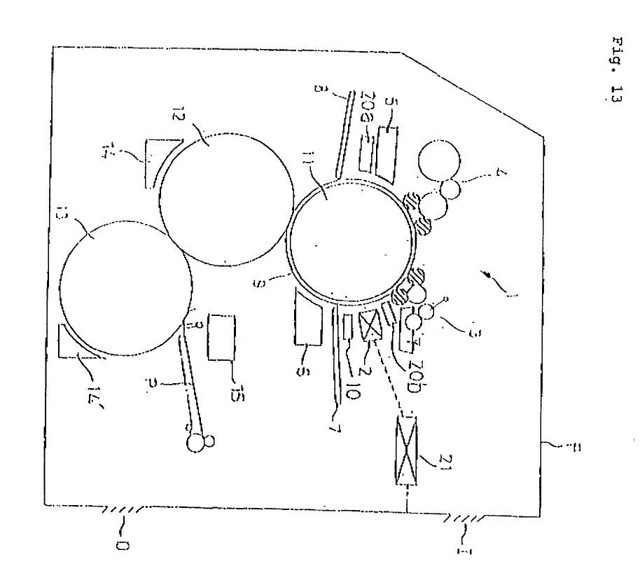

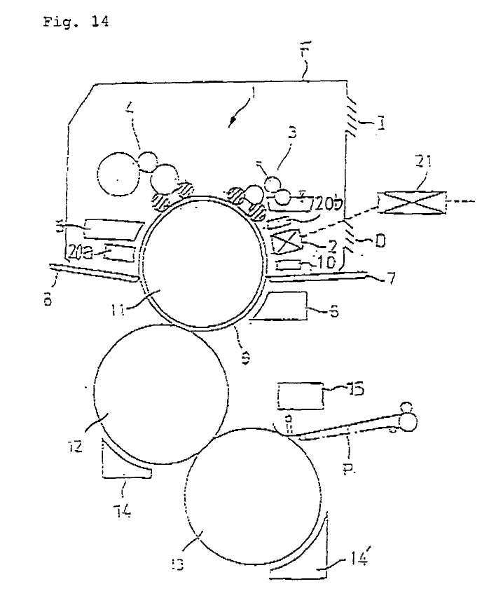

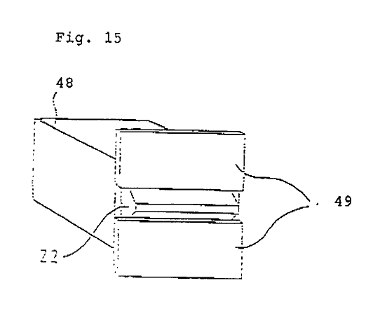

FIG. 1 is an overall schematic diagram illustrating an embodiment of the computer-to-cylinder recording type monochromatic lithographic printing apparatus. FIG. 2 is a schematic diagram illustrating an embodiment of the recording portion of the computer-to-cylinder recording type lithographic printing apparatus including a controller, an ink supplier and a head moving mechanism. FIGS. 3 and 4 are diagrams illustrating the subsidiary scanning control used in the present invention. FIGS. 5 to 11 are schematic diagrams illustrating the ink jet recording apparatus provided in the computer-to-cylinder recording type lithographic printing apparatus. FIG. 12 is an overall schematic diagram illustrating a computer- to-cylinder recording type four-color one-sided lithographic printing apparatus according to the present invention. FIGS. 13 and 14 are overall schematic diagrams illustrating another embodiment of the computer-to-cylinder recording type monochromatic lithographic printing apparatus according to the invention. FIG. 15 is a diagram illustrating an embodiment of the head protective cover used in the invention as a head protective means.

The printing process of the invention will be further described below in connection with the overall diagram of a computer-to-cylinder recording type monochromatic single-sided lithographic printing apparatus of FIG. 1.

As shown in FIG. 1, a press recording type lithographic printing apparatus 1 (hereinafter referred to as “printing apparatus”) 1 comprises a plate cylinder 11, a blanket cylinder 12 and an impression cylinder 13 provided therein. The transferring blanket cylinder 12 is arranged so as to be pressed against the plate cylinder 11 at least during lithographic printing. The impression cylinder 13 for transferring a printing ink image which has been transferred to the blanket cylinder 12 to a printing paper P is arranged pressed against the blanket cylinder 12.

FIG. 13 is a diagram illustrating the structure of another embodiment of the printing apparatus according to the invention. This printing apparatus is entirely covered by a hood F. The hood F comprises an air inlet I and an air outlet O. To the air inlet I and the air outlet O is attached a dust-removing filter (not shown). It is preferred that a fan or the like be provided inside the hood so that air is forced to enter into or be discharged from the hood.

Further, in a case where a solvent is used as an ink component, the hood may be provided with a solvent vapor removing device to prevent the vapor of the solvent from leaving out of the hood. When an electrostatic ink jet process is employed for the ink jet recording device, the necessity of discharging the solvent vapor out of the hood can be eliminated by the above-described arrangement, making it possible to provide a convenient printing apparatus which causes no problems of odor, etc. The printing apparatus of FIG. 13 is shown entirely covered by the hood F. However, the hood may cover a part of the printing apparatus as shown in FIG. 14. The present invention is not limited to these examples.

When an electrostatic ink jet process is employed for the ink jet recording device, the plate cylinder 11 is usually made of a metal. The surface of the plate cylinder 11 is plated with chromium to enhance its abrasion resistance. The plate cylinder 11 may have a heat insulator material on the surface thereof as described later. On the other hand, the plate cylinder 11 is preferably grounded because it acts as a counterelectrode to an electrode of the recording head when an electrostatic ink jet recording process is used. When the substrate of the printing plate precursor is a good insulator, a conductive layer may be provided on the substrate of the precursor. In this case, the conductive layer is preferably grounded to the plate cylinder. In a case where a heat insulator is provided on the plate cylinder 11 as described above, recording is more easily accomplished by providing the printing plate precursor with a ground. Examples of the ground employable herein include a known conductive brush, leaf spring, and roller.

The printing apparatus 1 also has an ink jet recording device 2 which ejects an ink containing a lipophilic component onto the printing plate precursor 9 mounted on the plate cylinder 11. The ink is ejected in accordance with image data transmitted from an arithmetic and control unit 21, to thereby form an image on the printing plate precursor.

The printing apparatus 1 further comprises a dampening water supplier 3 installed therein for supplying dampening water onto the water receptive layer (non-image area) of the printing plate precursor 9. FIG. 1 illustrates a Morton process water supplier as a typical example of the dampening water supplier 3. Other examples of the dampening water supplier 3 employable herein include known apparatus such as synchronous process water supplier and continuous process water supplier.

The printing apparatus 1 further comprises a printing ink supplier 4 and a fixing device 5 for adhering the ink image formed on the printing plate precursor 9. Additionally, a plate surface oil-desensitizing device 6 may be installed depending on the type of printing plate precursor 9 for increasing the hydrophilic properties of the surface of the printing plate precursor 9 as necessary.

The printing apparatus 1 also has a means 10 for removing dust present on the surface of the printing plate precursor before and/or during the process of recording the image on the printing plate precursor 9. Examples of the dust remover include a contact method using a brush or a roller, in addition to a conventional non-contact method involving suction, blowing or electrostaticity. In the present invention, the removal method is preferably one that uses suction, blowing or a combination thereof. In this case, an air pump commonly used for paper feeder may be used for this purpose.

An automatic plate material supplying device 7 by which the printing plate precursor 9 for printing is fed automatically to the plate cylinder 11, and an automatic plate material discharging device 8 by which the printing plate precursor 9 is removed from the plate cylinder 11 after the printing process may be installed. Examples of the press comprising these devices, which are known as auxiliary devices for press, include HAMADA VS34A, B452A (produced by HAMADA PRINTING PRESS CO., LTD.), TOKO 8000PFA (produced by Tokyo Koku Keiki K.K.), RYOBI 3200ACD, 3200PFA (produced by Ryobi Imagics Co., Ltd.), AMSIS Multi515PA (produced by Nihon AM Co., Ltd.), Oliber 266EPZ (produced by Sakurai Graphics Systems Co., Ltd.), and Sinohara 66IV/IVP (produced by Shinohara Shoji K.K.). Further, a blanket cleaner 14 and an impression cylinder cleaner 14′ may be installed. The use of these devices 7, 8, and 14 can make the printing operation simpler and shorter, so that the effects of the invention can be further enhanced. Further, a paper dust generation inhibiting device 15 may be installed in the vicinity of the plate cylinder 13, making it possible to prevent paper dust from adhering to the printing plate precursor. The paper dust generation inhibiting device 15 can operate by humidity control, suction by air or electrostaticity, or the like.

The arithmetic and control unit 21 receives image data from, e.g., an image scanner, a magnetic disk device or an image data communication device, and not only carries out color separation but also processing of the separated data into appropriate numbers of pixels and gradations. In addition to these operations, the control unit 21 calculates dot area percentage in order to enable the recording of images in halftone dots by means of an ejection head 22 (see FIG. 2 explained in detail hereinafter) with which the ink jet recording device 2 is equipped.

Furthermore, as described below, the arithmetic and control unit 21 controls the movement of ejection head 22 and the time at which the ink is ejected and, if desired, the timing of the rotation of the plate cylinder 11, the blanket cylinder 12, the impression cylinder 13, etc.

A method of preparing a printing plate using the printing apparatus 1 is described in detail below with reference to FIGS. 1, 13 and 14 and a portion of FIG. 2.

The printing plate precursor 9 is first mounted on the plate cylinder 11 using the automatic plate material supplying device 7. The printing plate precursor 9 is brought into close contact with and fixed firmly to the plate cylinder by means of a well-known mechanical device such as a plate end gripping device or an air suction device, or by a well-known electrostatic device. Due to this firm fixation, the end of the plate precursor 9 is prevented from flapping against and damaging the ink jet recording device 2 during the recording process. Also, it is possible to prevent the printing plate precursor 9 from scraping against the ink jet recording device by using an arrange which brings the printing plate precursor into close contact with the plate cylinder only in the neighborhood of the recording position of the ink jet recording device. Specifically, the arrange may be, for example, hold-down rollers disposed on both upstream and downstream sides of the recording position of the plate cylinder.

Further, a plate end non-contacting means may be provided such that the end of the printing plate precursor is kept away from the ink supplying roller during the fixing of the plate, making it possible to inhibit stain on the surface of the printing plate and hence reduce the number of sheets of waste paper. Specifically, hold-down rollers, guides, electrostatic attraction, etc. are effective.

Image data from a magnetic disc device or the like is given to the arithmetic and control unit 21. The arithmetic and control unit 21 then calculates the ejection position of ink containing a lipophilic component and dot area percentage at the ejection position according to the image data thus inputted. The arithmetic data input to the arithmetic and control unit 21 is temporarily stored in a buffer. The arithmetic and control unit 21 instructs the rotation of the plate cylinder 11 as shown in FIG. 2, at the same time, switches on a recording head moving device 31 which moves the recording head 22 towards or away from the plate cylinder 11. The distance between the recording head 22 and the surface of the printing plate precursor 9 mounted on the plate cylinder 11 is maintained at a predetermined value during recording at a desired value by mechanical distance control, e.g., using a contact roller or by controlling the ejection head moving device 31 in accordance with signals from an optical distance detector. For the ejection head 22, a multiple channel head can be used. The head is arranged so that the ejectors are aligned in the axial direction of the plate cylinder 11. Main scanning is carried out by rotating the plate cylinder 11.

According to instructions from the arithmetic and control unit 21, the head is moved in the direction parallel to the axis of rotation while the plate cylinder 11 is rotated at a predetermined speed. An ink containing a lipophilic component is ejected from the head towards the printing plate precursor 9 mounted on the plate cylinder 11 at a position and with the dot area percentage determined by operations performed by the control unit 21. As a result, a dot image with gradations corresponding to the original is recorded with the ink on the printing plate precursor 9 mounted on the plate cylinder 11. These operations are continued until the ink image corresponding to one-color information of the original is formed on the printing plate precursor to prepare a printing plate. As described above, the plate cylinder is rotated to effect main scanning so that positional precision in the main scanning direction is enhanced and high-speed recording becomes feasible.

Subsequently, the recording head 22 is moved away from the position close to the plate cylinder 11 in order to protect the recording head 22. During this operation, only the recording head 22 may be moved away from the plate cylinder 11. However, the recording head 22 may be moved away from the plate cylinder 11 together with a head subsidiary scanning means 32 or together with the ink supplier 24 and the head subsidiary scanning means 32. Alternatively, an arrangement may be made such that the fixing device 5 and the dust remover 10 can be moved away from the plate cylinder 11 in the same manner as the recording head 22, the ink supplier 24 and the head subsidiary scanning means 32, whereby the printing apparatus can be used also in ordinary printing.

The device for moving the head towards and away operates so as to keep the recording head at least 500 μm away from the plate cylinder except during image recording. This movement may be effected using a sliding system or a mechanism by which the head is gripped with an arm fixed on a shaft and moved in a pendulum-like motion by turning the shaft. By keeping the head away from the plate cylinder when image formation is not being carried out, the head is protected from physical damage and contamination. As a result, the life of the head can be extended.

The ink image formed by the head may be hardened by heating or like means using a fixing device 5. Well-known fixing techniques, such as heat fixing, solvent fixing and exposure to UV rays, can be employed for fixing the ink image. In the case of heat fixing, irradiation with light beam from infrared lamp, halogen lamp and xenon flash lamp, hot air fixing using a heater or fixing using a heated roller can be usually used. In such a case, for increasing the fixing efficiency, means made be adopted such as previously heating the plate cylinder, previously heating the printing plate precursor, performing the recording under exposure to hot air, using a plate cylinder coated with a heat insulator, or heating the printing plate precursor alone by separating the printing plate precursor from the plate cylinder only at the time of fixing. Flash fixing using, e.g., a xenon lamp, is well-known as a fixing method for electrophotographic toner, and has the advantage of performing the fixing in a short time.

In the case of solvent fixing, a solvent capable of dissolving the resin component of the ink, such as methanol and ethyl acetate, is sprayed onto the printing plate precursor, and the excess solvent vapor is recovered. Fixing by irradiation with UV rays is useful in the case where a UV ink is used. It is desirable, at least during the portion of the process from formation of the image by means of the recording head 22 to the fixing of the image with the fixing device 5, for the dampening water supplier 3, the printing ink supplier 4 and the blanket cylinder 12 to be prevented from coming into contact with the printing plate precursor 9 on the plate cylinder.

The printing plate thus prepared is then subjected to printing process in the same manner as known lithographic printing method. More specifically, the printing plate 9 having the ink image containing a lipophilic component formed thereon is given a printing ink and a dampening water to form a printing ink image thereon. The printing ink image thus formed is transferred onto a blanket cylinder 12 rotating in concert with the plate cylinder 11, and then the printing ink image on the blanket cylinder 12 is transferred to printing paper passing between the blanket cylinder 12 and the impression cylinder 13 to conduct printing corresponding to one-color information of the original. After the printing operation, the printing plate is removed from the plate cylinder 11 by an automatic plate remover 8, and a blanket on the blanket cylinder 12 is cleaned with a blanket cleaning device 14 so that it is restored to a printable state.

The reference numeral 20a indicates a digital controlling means which can be provided for the purpose of further improving the operability of the computer-to-cylinder recording type lithographic printing apparatus 1 of the invention, such as ink usage indicator and plate detector. The ink usage indicator is adapted to previously indicate the required amount of ink according to image data and thus is very useful for continuous plate making as in the present printing apparatus 1.

The present printing apparatus performs an on-the-recording and thus doesn't allow detection of the recorded images on the printing plate and plate inspection. The foregoing plate detector compensates for this disadvantage, i.e., for carrying out plate inspection. In some detail, the image recorded on the printing plate is detected, e.g., by a CCD camera provided in the printing apparatus so that it is displayed on a monitor, enabling detection and inspection of the printing plate. If necessary, the image thus detected can be digitally processed, making the plate inspectability higher than observed visually.

The ink jet recording device 2 will be described in more detail below in connection with FIG. 2.

The image recording portion used in the lithographic printing device of the invention comprises an ink jet recording device 2 including an ink jet ejection head 22, a head protective means 20b, and an ink supplier 24, as shown in FIG. 2. Examples of the head protective means 20b include (1) means for preventing the attachment of foreign matters to the head, and (2) means for suspending image recording upon the occurrence of abnormality.

An example of the means for preventing the attachment of foreign matters to the head is a head protective cover. In other words, by housing the head in the cover when no image is not recorded, the attachment of foreign matters to the head can be prevented. FIG. 15 indicates an embodiment of the cover according to the invention. As shown in FIG. 15, the head 22 is housed in a cover 48 with a shutter 49. In order to record an image, the shutter 49 is opened so that the head 22 can move forward to the image recording position where image recording is then effected. The interior of the cover 48 may be filled with an ink or ink solvent. In this arrangement, any troubles due to the attachment of the ink to the head 22 can be prevented even if image recording is not effected for a long period of time.

An example of the means for suspending image recording upon the occurrence of abnormality (2) is a dust detector or head abnormal current detector which is connected to the image data arithmetic and control unit 21 so that when any abnormal signal is generated from the detector, the supply of voltage signal to the head is suspended, giving a mechanism that makes it possible to prevent the damage to the head.

The ink supplier 24 has an ink tank 25, an ink supplier 26 and an ink concentration controlling member 29. The ink tank 25 may be furnished with a stirrer 27 and an ink temperature controlling device 28 as necessary. The ink may be circulated through the ejection head. In this case, the ink supplier has a recovering function in addition to the circulatory function. The stirrer 27 may be supplied to inhibit the solid component of the ink from precipitating and aggregating. Examples of the ink stirrer include a rotating blade, an ultrasonic vibrator and a circulatory pump. These tools can be used singly or in combination. The ink temperature controlling device 28 is arranged so as to prevent the physical properties of the ink from changing due to change in ambient temperature, thereby ensuring no change in dot diameter so as to form a consistently high-quality image.

To control the ink temperature, a well-known method can be adopted. More specifically, the ink tank can be provided with a heating element such as a heater or a Peltie element or a cooling element together with the stirrer so as to make the temperature distribution inside the ink tank uniform, and the temperature is controlled with a temperature sensor such as thermostat. It is desirable that the ink temperature inside the ink tank be from 15° C. to 60° C., and preferably from 20° C. to 50° C. The stirrer may be used for both purposes of keeping the temperature distribution uniform and for preventing precipitation and aggregation of the solid component of the ink.

For achieving high-quality image formation, the printing apparatus of the present invention is further provided with an ink concentration controlling member 29 as needed. Ink concentration control is carried out by optical detection, measurement of physical properties such as electric conductivity or viscosity, or monitoring a number of printing plate precursors subjected to image formation. More specifically, the ink concentration is controlled by feeding concentrated ink from an ink tank for replenishment or ink carrier tank for dilution (not shown) in accordance with output signals from an optical detector, a conductivity measuring instrument and a viscosity measuring instrument provided individually or in combination inside the ink tank, or ink flow course in the case of control in accordance with measurement of physical properties, or based on a number of printing plates made or a frequency of plate-making operations in the case of monitoring the number of printing plate precursors subjected to image formation.

The image data arithmetic and control unit 21, as described above, not only performs arithmetical operations on input image data and controls movement of the ejection head with the ejection head moving device 31 or the head subsidiary scanner 32 and rotation of the plate cylinder, but also receives a timing pulse from an encoder 30 attached to the plate cylinder and carries out operation of the ejection head 22 in accordance with the timing pulse. As a result, positional precision in the direction of subsidiary scanning is improved. The image data arithmetic and control unit 21 also controls the foregoing head protective means 20b. During the image recording by the ink jet recording device, the use of a driving means having a high precision different from the driving means for printing allows the plate cylinder 11 to be driven in an enhanced positional precision in the direction of subsidiary scanning. During this procedure, the plate cylinder is preferably released mechanically from the blanket cylinder 12, the impression cylinder 13 and others so that only the plate cylinder 11 can be driven. More specifically, the output from a high precision motor can be subjected to reduction through a high precision gear, steel band or the like to drive only the plate cylinder 11. During the recording of a high quality image, these means may be used singly or in combination.

An example of subsidiary scanning control according to the present invention will be described hereinafter in connection with FIGS. 3 and 4. However, the present invention should not be limited to the following description. FIG. 3 illustrates an example of recording positions on the first to sixth rotations during the recording of image on the printing plate precursor in the direction perpendicular to the rotation of the plate cylinder with a recording resolution (N) of 600 dots/25.4 mm using a head having three ejection channels (X=1) and a channel density of 300 (dots/25.4 mm). FIG. 4 illustrates a general example of recording positions on the rotation of the order of from (n−2) to (n+3). FIG. 3 is a plan view illustrating by way of example for the purpose of explaining the dot recording position on the actual plate cylinder the dot recording positions on the plate cylinder on the first rotation, on the second rotation, . . . on the sixth rotation, which are shown running continuously from up to down. FIG. 4 is shown similarly. The first dot in the direction of main scanning, the second dot in the direction of main scanning, . . . the final dot in the direction of main scanning are actually separated from each other. However, these dots are shown by line. For the simplification of description, images are shown recorded on the entire surface of the plate cylinder. However, it is usual that the plate cylinder has some area which is not used for recording such as area at which the printing plate precursor is gripped.

In FIG. 3, the solid lines 1, 2 and 3 on the first rotation indicate recording made by the first, second and third channels of the head, respectively. In FIG. 3, the vertical direction from up to down indicates the direction of main scanning while the horizontal direction from left to right (moving direction of head in this case) indicates the direction of subsidiary scanning. Accordingly, the uppermost part of the solid lines 1, 2 and 3 on the first rotation are the first dot position of the various channels in the direction of main scanning, and the lowermost part of the solid lines 1, 2 and 3 are the last dot position of the various channels in the direction of main scanning. As can be seen in the second rotation, the last dot position (a) on the second rotation recorded by the first channel is just in between the last dot position (b) of the line recorded by the second channel on the first rotation and the last dot position (c) of the line recorded by the third channel on the first rotation. In other words, the first channel moves by 3 dots in the direction of subsidiary scanning on one rotation. Other two channels, too, each move by 3 dots in the direction of subsidiary scanning on one rotation. Similarly, as can be seen in the third rotation, the last dot position (d) on the third rotation recorded by the first channel is just in between the last dot position (e) of the line recorded by the second channel on the second rotation and the last dot position (f) of the line recorded by the third channel on the second rotation. This mechanism follows on the subsequent rotations.

As a result, the recording positions made by the various channels on the various rotations extend at a pitch equal to half that of the various channels as can be seen in the sixth rotation (lowermost part of FIG. 3).

FIG. 3 is a diagram of pattern beginning with the first rotation. FIG. 4 is a generalized form of the pattern of FIG. 3. In FIG. 4, the last dot position recorded by the first channel on the rotation of the order of (n−1) lies in between the last dot position recorded by the second channel and the last dot position recorded by the third channel on the rotation of the order of (n−2). As a result, it can be seen that the recording positions recorded by the various channels on the various rotations extend at a pitch equal to half that of the various channels.

The foregoing description refers to the case where one head has 3 channels. Even when the number of channels per head is changed, the movement of the head in the direction of subsidiary scanning can be varied accordingly to provide a recording resolution having a density higher than the channel density in the direction of subsidiary scanning of the head.

Some examples of such an arrangement will be given below.

1) In the case where the resolution of recording on the printing plate precursor in the direction perpendicular to the rotation of the plate cylinder is 200 dots/25.4 mm and the channel density of the ejection head in the direction perpendicular to the rotation of the plate cylinder is 100 dots/25.4 mm, the ejection head may be moved at a rate of 3 dots per rotation, if it has 3 ejection channels, or S dots per rotation, if it has 5 ejection channels, in the direction of subsidiary scanning. Further, the ejection head, if it has 7 ejection channels, may be moved at a rate of 7 dots per rotation in the direction of subsidiary scanning. The ejection head, if it has 65 ejection channels, may be moved at a rate of 65 dots per rotation in the direction of subsidiary scanning.

2) In the case where the resolution of recording on the printing plate precursor in the direction perpendicular to the rotation of the plate cylinder is 300 dots/25.4 mm and the channel density of the ejection head in the direction perpendicular to the rotation of the plate cylinder is 100 dots/25.4 mm, the ejection head may be moved at a rate of 4 dots per rotation, if it has 4 ejection channels, or 7 dots per rotation, if it has 7 ejection channels, in the direction of subsidiary scanning. Further, the ejection head, if it has 10 ejection channels, may be moved at a rate of 10 dots per rotation in the direction of subsidiary scanning. The ejection head, if it has 97 ejection channels, may be moved at a rate of 97 dots per rotation in the direction of subsidiary scanning.

3) In the case where the resolution of recording on the printing plate precursor in the direction perpendicular to the rotation of the plate cylinder is 400 dots/25.4 mm and the channel density of the ejection head in the direction perpendicular to the rotation of the plate cylinder is 200 dots/25.4 mm, the ejection head may be moved at a rate of 3 dots per rotation, if it has 3 ejection channels, or 5 dots per rotation, if it has 5 ejection channels, in the direction of subsidiary scanning. The ejection head, it it has 65 ejection channels, may be moved at a rate of 65 dots per rotation in the direction of subsidiary scanning.

4) In the case where the resolution of recording on the printing plate precursor in the direction perpendicular to the rotation of the plate cylinder is 600 dots/25.4 mm and the channel density of the ejection head in the direction perpendicular to the rotation of the plate cylinder is 200 dots/25.4 mm, the ejection head may be moved at a rate of 4 dots per rotation, if it has 4 ejection channels, or 7 dots per rotation, if it has 7 ejection channels, in the direction of subsidiary scanning. Further, the ejection head, if it has 10 ejection channels, may be moved at a rate of 10 dots per rotation in the direction of subsidiary scanning. The ejection head, if it has 97 ejection channels, may be moved at a rate of 97 dots per rotation in the direction of subsidiary scanning.

The foregoing arrangement can be represented by the following general formula.

The ejection head having ejection channels in an amount represented by (X·(N/K)+1) may be moved in the direction of subsidiary scanning continuously at a constant speed of (X·(N/K)+1) [dot/rotation], wherein N [dots/25.4 mm] represents the resolution in image recording on the printing plate precursor in the direction perpendicular to the rotation of the plate cylinder, K [dots/25.4 mm] represents the density of channels in the ejection head in the direction perpendicular to the rotation of the plate cylinder, and X represents an arbitrary positive integer.

Thus, in accordance with the present invention, even if an expensive subsidiary scanning control system is not used, the precision in the dot position in the direction of subsidiary scanning can be enhanced as compared with the case where the ejection head is moved successively, making it possible to provide a good image quality.

The ejection head will now be described in more detail with reference to FIGS. 5 to 11 which illustrate examples of the ejection head suitable for the electrostatic ink jet process that can be employed in the present invention. However, the present invention should not be construed as being limited thereto.

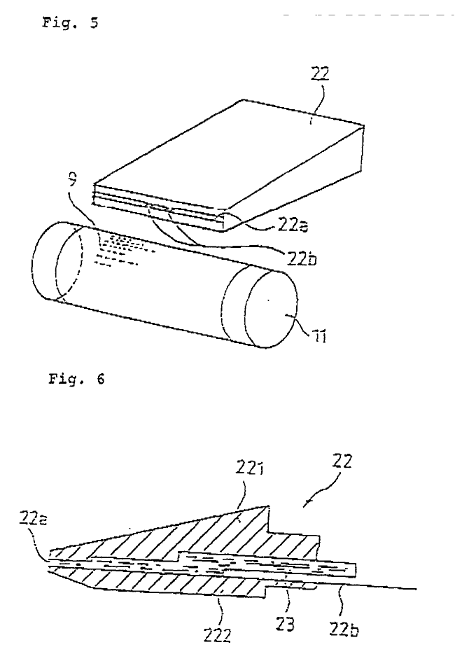

FIGS. 5 and 6 show an example of an ejection head which is installed in the ink jet recording device. The ejection head 22 has a slit interposed between an upper unit 221 and a lower unit 222, each formed by an insulating substrate, while the tip thereof forms an ejection slit 22a. An ejection electrode 22b is arranged in the slit, and the slit is filled with an ink 23 supplied from an ink supplying device. Examples of the insulating substrate usable for the head include plastics, glass and ceramics. The ejection electrode 22b is formed on the lower unit 222 made of an insulating substrate according to a known method. For instance, the top surface of the lower unit 222 may be provided with a conductive material such as aluminum, nickel, chromium, gold or platinum using a technique such as vacuum deposition, sputtering or electroless plating, and then the conductive material coating is covered with a photoresist. The photoresist is exposed to light via a desired electrode pattern and developed to form a photoresist pattern in the form of the ejection electrode 22b. Then, the conductive material coating undergoes etching, mechanical removal or a combination thereof to form the ejection electrode 22b.

During operation of the ejection head 22, a voltage is applied to the ejection electrode 22b in accordance with digital signals corresponding to image pattern information. As shown in FIG. 5, the ejection electrode 22b is arranged facing the plate cylinder 11 so as to constitute a counterelectrode, and the printing plate precursor 9 is mounted on the plate cylinder as the counterelectrode. Upon application of voltage, a circuit is formed between the ejection electrode 22b and the plate cylinder 11 acting as the counterelectrode, and the oil-based ink 23 is ejected from the ejection slit 22a of the ejection head 22 to form an image on the printing plate precursor 9 mounted on the plate cylinder 11 as the counterelectrode.

In order to form a high-quality image, it is preferred that the tip of the ejection electrode 22b is made as small as possible. The tip of the electrode is ordinarily shaped so as to have a width of from 5 to 100 μm, although the tip width may be varied depending on conditions such as voltage applied and physical properties of ink.

For instance, a dot having a diameter of 40 μm can be formed on the printing plate precursor 9 when an ejection electrode 22b having a tip width of 20 μm is used, the space between the ejection electrode 22b and the plate cylinder 11 as a counterelectrode is adjusted to 1.0 mm, and a voltage of 3 kV is applied for 0.1 millisecond between these electrodes.

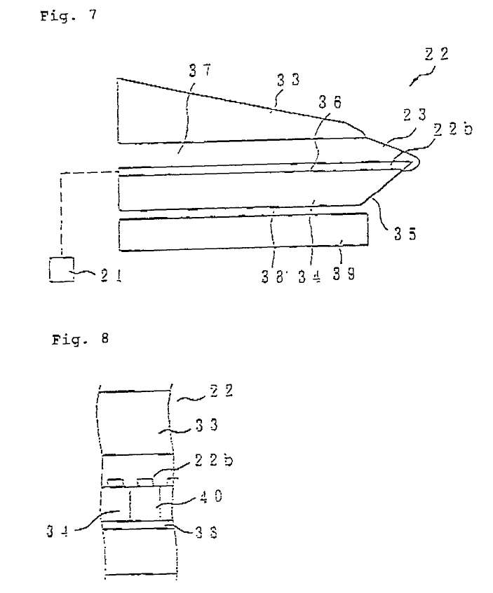

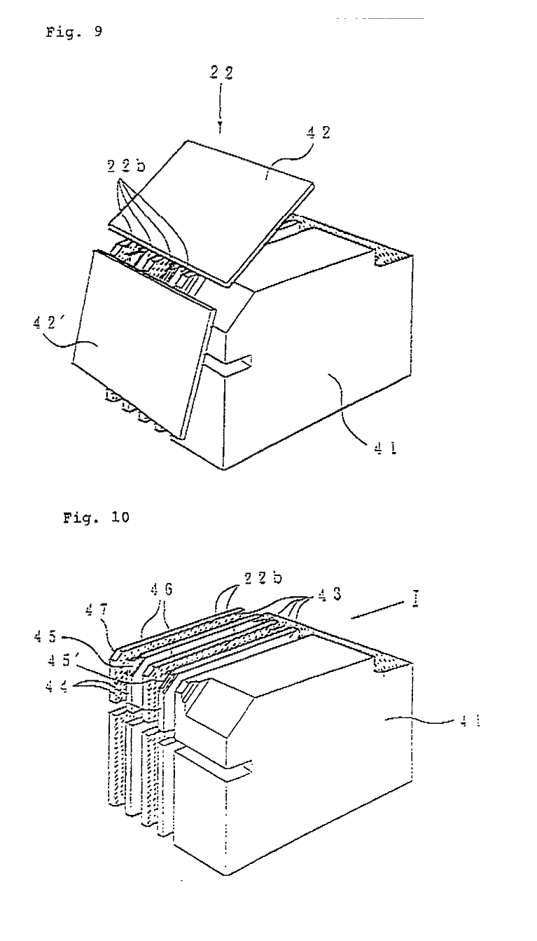

FIGS. 7 and 8 respectively show a schematic cross-sectional view and a schematic front view of the vicinity of an ink ejector of another example of the ejection head-Reference numeral 22 in these figures indicate the ejection head. The head has a first insulating substrate 33 of a tapered shape. A second insulating substrate 34 is set facing to and apart from the first insulating substrate 33. An end portion of the second insulating substrate 34 has a slope 35. The first and second insulating substrates are each made of, e.g., plastics, glass or ceramics.

On a top surface 36 of the second insulating substrate 34, which makes a sharp angle with the slope 35, a plurality of ejection electrodes 22b are provided for forming an electrostatic field in the ejector. The tips of the ejection electrodes 22b extend to the vicinity of the tip of the top surface 36, and protrude beyond the tip of the first insulating substrate 33, thereby forming the ejectors. An ink inflow course 37, defining a pathway for supplying ink 23 to the ejector, is formed between the first and second insulating substrates 33 and 34, and the ink recovery course 38 is formed on the underside of the second insulating substrate 34. The ejection electrodes 22b are formed using a conductive material such as aluminum, nickel, chromium, gold or platinum on the top surface of the second insulating substrate 34 in a conventional manner as described above. The respective election electrodes 22b are constructed so as to be in an electrically insulated state.

A suitable length for the tip of the ejection electrode 22b that protrude beyond the tip of the first insulating substrate 33 is 2 mm or less. A reason why such a range of protrusion is preferred is that, if the protrusion is too long, it is difficult for the ink meniscus to reach the tip of ejector, resulting in difficulty in ejection of the ink and a decrease in maximum recording frequency. Also, it is preferred that the space between the first and second insulating substrates 33 and 34 be from 0.1 to 3 mm. A reason why this range is preferred for the space is that too narrow a space makes supply of the ink difficult, resulting in difficulty in ejection of the ink and a decrease in maximum recording frequency while, on the other hand, too wide a'space makes the meniscus unstable, resulting in inconsistent ejection of the ink.

The ejection electrode 22b is connected to the arithmetic and control unit 21. In carrying out recording, a voltage is applied to the ejection electrode in accordance with image information signals from the arithmetic and control unit 21, and thereby the ink on the ejection electrode is ejected to perform image formation on a printing plate precursor (not shown) arranged to be facing to the ejector. The ink inflow course 37 is connected to a device for sending ink from an ink supplying device (not shown) on the side opposite to the ink ejector. Further, a backing 39 is arranged apart from and facing toward the underside, which is the reverse of the ejection electrode side, of the second insulating substrate 34 to form an ink recovery course 38 between the backing and the underside of the second insulating substrate 34. It is preferred that the width of the space of the ink recovery course 38 be at least 0.1 mm. This is because too small a space makes the recovery of ink difficult, resulting in ink leakage. The ink recovery course 38 is connected to an ink recoverer, which is attached to the ink supplying device (not shown). If a uniform ink flow over the ejector is required, grooves 40 may be provided between the ejector and the ink recoverer.

FIG. 8 is a front view showing the vicinity of the ejector of an ejection head. As shown in FIG. 7, a plurality of grooves 40 are provided in the slope of the second insulating substrate 34 from the vicinity of the borders with the respective ejection electrodes 22 to the ink recovery course 38. The grooves 40 are aligned in the lengthwise direction of the ink jet electrode 22b, and have a function for conducting by capillary action a predetermined amount of ink, depending on the opening diameter, present in the vicinity of the tip of each ejection electrode from the respective openings on the side of ejection electrodes 22b into the ink recovery course 38. Thus, the grooves 40 function to form an ink flow having a certain thickness in the vicinity of the tip of each ink jet electrode. The groove 40 may have any shape as far as the grooves can provide the desired capillary action. However, it is especially desirable that the width of the grooves is from 10 to 200 μm and the depth thereof is from 10 to 300 μm. The grooves 40 are provided in a number sufficient for forming a uniform ink flow over the entire ejection head.

In order to effect formation of a high-quality image, it is preferred that the tip of the ejection electrode 22b be made as small as possible. The tip of the electrode is ordinarily shaped so as to have a width of from 5 to 100 μm, although the tip width may be varied depending on conditions such as voltage applied and physical properties of ink.

Still another example of the ejection head for use in the present invention is shown in FIGS. 9 and 10. FIG. 9 is a schematic diagram illustrating only a portion of the head. The ejection head 22, as shown in FIG. 9, has a main body 41 made of an insulating material such as plastics, ceramics or glass, and meniscus regulating panels 42 and 42′. Reference numeral 22b in FIG. 9 indicates an ejection electrode to which a voltage is applied to form an electrostatic field in the ejector. The main body 41 of the head is further illustrated in detail with reference to FIG. 10 wherein the regulating panels 42 and 42′ are removed from the ejection head. The main body 41 of the head has a plurality of ink grooves 43 cut perpendicularly to the edge thereof for the purpose of ink circulation. The grooves 43 each may have any shape so far as the grooves can provide a suitable capillary action sufficient to form a uniform ink flow. However, it is especially desirable that the width of the groove be from 10 to 200 μm and the depth thereof be from 10 to 300 μm.

Ejection electrodes 22b are provided in respective ones of the grooves 43. In each of the grooves 43 the ejection electrode 22b may be arranged so as to cover the entire surface of the groove or it may be formed on only a portion of the groove using a conductive material such as aluminum, nickel, chromium, gold or platinum, according to a well-known method as described in the above-described example of the head. Additionally, the ejection electrodes are electrically isolated from one another. Two ink grooves adjacent to each other form one cell, and a separator wall 44 positioned in the center of the cell has an ejector 45 or 45′ in the tip. The separator wall 44 is made thinner in the ejector 45 or 45′ than in other portions thereof, and the ejector is sharpened.

The main body of the head having the configuration method such as mechanical processing or etching of a block of insulating material, or molding of an insulating material. It is desirable that the separator wall in the ejector have a thickness of from 5 to 100 μm and the sharpened tip thereof have a radius of curvature of from 5 to 50 μm. Further, the tip of the ejector may be slightly cut off as shown in the ejector 45′. In the figure, only two cells are depicted for ease of illustration. A separator wall 46 is disposed between cells. The tip 47 of the wall 46 is cut off so as to be set back compared with the ejectors 45 and 45′. The ink is flowed into the ejection head via ink grooves from the direction indicated by an arrow I with from an ink supplying device (not shown), and thereby supplied to the ejectors. Further, the excess ink is recovered in the direction indicated by an arrow O with an ink recoverer (not shown). As a result, fresh ink is always supplied to each ejector. A plate cylinder holding a printing plate precursor on the surface thereof (not shown) is arranged so as to face the ejector. While maintaining such a condition, a voltage corresponding to the image information is applied to the ejection electrode, and ink is ejected from the ejector to form an image on the printing plate precursor.

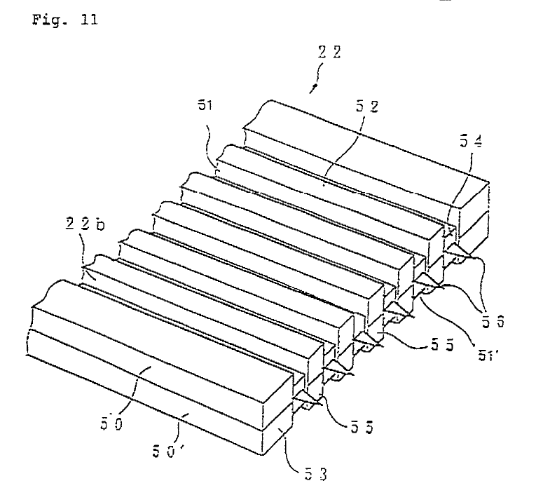

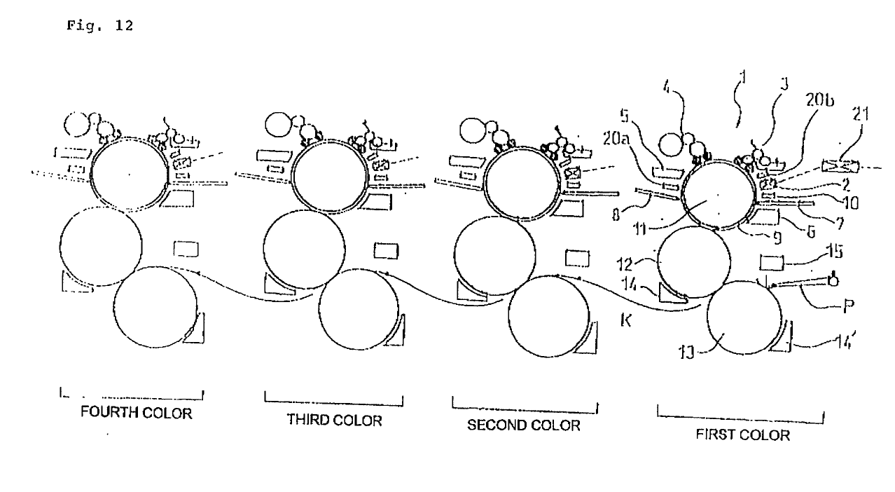

Still another example of the ejection head is described with reference to FIG. 11. As shown in FIG. 11, the ejection head 22 has a pair of nearly rectangular plate-shaped support members 50 and 50′. Each of these support members 50 and 50′ is made of an insulating plastic, glass or ceramic plate having a thickness of from 1 to 10 mm, and in one surface thereof there are formed a plurality of rectangular grooves 51 or 51′ extending parallel to one another. Each of the grooves 51 and 51′ desirably has a width of from 10 to 200 μm and a depth of from 10 to 300 μn. In each of the grooves, an ejection electrode 22b is formed so as to cover the whole or only a portion of the groove surface. The formation of a plurality of grooves 51 or 51′ in one surface of each support member 50 or 50′ results in the formation of rectangular separator walls 52 between respective pairs of grooves.

The support members 50 and 50′ are placed together so that the surfaces thereof in which no grooves are formed are brought into contact with each other. Specifically, the ejection head 22 has a plurality of grooves for distribution of ink over the periphery thereof. The grooves 51 formed in the support member 50 are coupled to corresponding ones of the grooves 51′ formed in the support member 50′ by way of the rectangular portion 54 of the ejection head 22. Each rectangular portion 54 that couples together two corresponding grooves is set back a predetermined distance (e.g., 50 to 500 μm) from the top end portion 53 of the ejection head. In other words, each of the separator walls 52 adjoining each rectangular portion 54 on both sides is disposed so that the top end 55 thereof protrudes beyond the adjacent rectangular portions 54. Also, a guide protrusion 56 made of an insulating material as described above is attached so as to protrude beyond each rectangular portion 54, thereby forming the ejector.

When ink is circulated through the ejection head 22 having the structure as described above, the ink is supplied to each rectangular portion 54 via a respective groove 51 formed at the periphery of the support member 50, and the ink is discharged via the grooves 51′ formed in the support member 50′ opposite the support member 50. In this case, the ejection head 22 is inclined at a predetermined angle so that the ink supply side (the support member 50) is situated upward and the ink discharge side (the support member 50′) is situated downward. By circulating the ink through the ejection head 22 in such a manner, the ink passing across each rectangular portion 54 flows forward along the guide protrusions 56 to form an ink meniscus in the vicinity of the rectangular portion 54 and the protrusion 56. A plate cylinder holding a printing plate precursor on the surface thereof (not shown) is arranged so as to face the ejector. With independent ink meniscuses formed on the respective rectangular portions 54, a voltage corresponding to the image information is applied to the ejection electrode, and the ink is ejected from the ejector to form an image on the printing plate precursor. A cover may be attached along the periphery of each of the support members 50 and 50′ to cover the grooves, thereby forming pipe-shaped ink flow courses along the periphery of each of the support members 50 and 50′. In such a case, since the ink can be made to circulate by way of these ink flow courses, it is not necessary to incline the ejection head 22.

The ejection heads 22 can also be provided with a maintenance device such as a cleaner if desired. For instance, in a case where recording has been suspended for a certain period or problems in image quality occur, a device for wiping the tip of the ejection head with a flexible brush or cloth, a device for circulating the ink solvent alone, and a device for exerting suction on the ejector while supplying or circulating the ink solvent alone can be adopted singly or in combination, whereby satisfactory recording conditions can be maintained. In order to prevent the ink from solidifying inside the ejection head, it is also effective to cool the ejection head, thereby reducing evaporation of the ink solvent. Further, if the contamination of the head is severe, a method of suctioning ink from the ejector, a method of blowing air in the ink flow course, and a method of applying ultrasonic waves to the head while immersing the head in an ink solvent are also effective. These methods can be used alone or in combination.

Further, the head 22 may comprise a temperature controlling member as necessary. This arrangement makes it possible to prevent the change in the physical properties of the ink due to change in the ambient temperature and hence prevent the variation of dot diameter. This mechanism can be realized by the use of a known system having a heat generating element such as heater and Peltie element or a cooling element arranged such that the temperature of the head can be kept constant under the control by a temperature sensor such as thermostat. The temperature of the head is preferably from 15° C. to 60° C., more preferably from 20° C. to 50° C.

A specific example will be described hereinafter with reference to a computer-to-cylinder recording type multi-color lithographic printing apparatus.

FIG. 12 is a schematic diagram illustrating the entire configuration of a computer-to-cylinder recording type four-color single-sided sheet-feed lithographic printing apparatus. As shown in FIG. 12, the four-color single-sided printing apparatus essentially comprises four plate cylinders 11, four blanket cylinders 12 and four impression cylinders 13 of the monochromatic single-sided printing apparatus shown in FIG. 1 arranged for each of four colors such that printing is effected on the same surface of printing paper P. Though not shown, the delivery of printing paper from an impression cylinder to another as shown by K is carried out by a known delivery cylinder or the like. Although detailed description is omitted, as can be easily seen in the example of FIG. 12, other multi-color single-sided printing apparatus each essentially comprise a plurality of plate cylinders 11, blanket cylinders 12 and impression cylinders 13 arranged for each color such that printing is effected on the same surface of printing paper P. In the case where only one printing plate is prepared for each plate cylinder, there are provided plate cylinders and blanket cylinders in an amount corresponding to the number of colors to be printed. Such a printing apparatus is referred to as “unit type printing apparatus.

On the other hand, in the case where the present invention is implied in the form of a common impression cylinder type printing apparatus which shares one impression cylinder having a diameter which is an integral multiple of the diameter of the plate cylinder among plate cylinders and blanket cylinders in an amount corresponding to the number of a plurality of colors, the arrangement may be such that one impression cylinder is shared by plate cylinders and blanket cylinders in an amount corresponding to the number of colors to be printed. Alternatively, the arrangement may be such that the total number of plate cylinders and blanket cylinders corresponds to the number of colors to be printed. In this arrangement, the delivery of printing paper between adjoining common impression cylinders may be carried out by the foregoing known delivery cylinder or the like.

On the other hand, in the case where a plurality of color printing plates are prepared for each plate cylinder, plate cylinders and blanket cylinders are necessary in an amount corresponding to the value obtained by dividing the number of colors to be printed by the number of printing plates per plate cylinder. For example, when two color printing plates are prepared per plate cylinder, a press comprising two plate cylinders and two blanket cylinders can be used to effect four-color printing on one side of printing paper. In this case, the diameter of the impression cylinder is the same as that of the plate cylinder for one color. If necessary, the impression cylinder is provided with a means for holding printing paper until printing of the required number of colors is completed. The delivery of printing paper can be accomplished by a known delivery cylinder or the like. In the case of a press having two plate cylinders having the foregoing two color printing plate precursors formed thereon and two blanket cylinders, when one of the two impression cylinders rotates twice holding printing plate, two-color printing is effected. Subsequently, printing paper is delivered between the impression cylinders. When the other impression cylinder rotates twice holding printing paper, another two-color printing is effected, thereby completing four-color printing. The number of impression cylinders to be installed may be the same as that of plate cylinders. Several plate cylinders and blanket cylinders may have one impression cylinder in common.

On the other hand, in the case where the present invention is implicated in the form of computer-to-cylinder recording type multi-color double-sided lithographic printing apparatus, a known printing paper inverting means is provided in at least one gap between adjacent impression cylinders in the foregoing unit type printing apparatus or in at least one gap between adjacent impression cylinders in an arrangement having a plurality of the foregoing common impression cylinder type printing apparatus. Alternatively, a plurality of the plate cylinders 11 and blanket cylinders 12 in the monochromatic single-sided printing apparatus shown in FIG. 1 are provided. In the latter structure, in the case where only one color printing plate is prepared for each plate cylinder, there are provided plate cylinders and blanket cylinders in an amount corresponding to the number of colors to be printed on both surfaces of printing paper. On the other hand, in the case where a plurality of color printing plates are prepared for each plate cylinder as mentioned above, the required number of plate cylinders, blanket cylinders and impression cylinders can be reduced. Further, in the case where several plate cylinders and blanket cylinders have one impression cylinder in common, the required number of impression cylinders may be reduced, too. If desired, the plate cylinder is provided with a means for holding printing paper until the desired number of colors is printed. The detail of the configuration of this system can be easily inferred from the foregoing example of computer-to-cylinder recording type multi-color single-sided lithographic printing apparatus and thus will not be described hereinafter.

The embodiment of implication of the computer-to-cylinder recording type lithographic printing apparatus according to the present invention has been described with reference to an example of sheet-feed press. In the case where the present invention is implicated as a computer-to-cylinder recording type multi-color WEB (paper roll) lithographic printing machine, on the other hand, the foregoing unit type or common impression cylinder type printing machine can be used to advantage. In the case where the present invention is implicated as a computer-to-cylinder recording type multi-color WEB (paper roll) double-sided printing machine, both the unit type and common impression cylinder type printing machine can be realized by arranging a plurality of structures each comprising a known WEB inverting means provided in at least one gap between adjacent impression cylinders such that printing is effected on both surfaces of printing paper P. Most preferred among computer-to-cylinder recording type multi-color WEB (paper roll) double-sided printing apparatus is BB (blanket-to-blanket) type printing machine. This type of printing machine comprises one plate cylinder and blanket cylinder (no impression cylinder) for one color to be printed on one surface of WEB and one plate cylinder and blanket cylinder (no impression cylinder) for the same color to be printed on the other surface of WEB, the blanket cylinders being pressed against each other during printing. This structure is provided in an amount corresponding to the number of colors to be printed, WEB passes through the gap between the blanket cylinders which are pressed against each other during printing to perform multi-color double-sided printing.

Another example of the computer-to-cylinder recording type lithographic printing apparatus comprises two plate cylinders per blanket cylinder, whereby printing is effected on one of the two plate cylinders while image recording is being effected on the other. In this case, it is desirable that the plate cylinder on the part of image recording be driven while being mechanically separated off from the blanket cylinder. In this manner, image recording is made possible without suspending the operation of the press. As can be easily inferred, this mechanism can be applied to computer-to-cylinder recording type multi-color single-sided lithographic printing apparatus and computer-to-cylinder recording type multi-color double-sided lithographic printing apparatus.

Though having not been described for the purpose of avoiding duplication, the hood, digital controlling means and head protective means can be all properly applied to the printing apparatus to improve the operability thereof.

The plate material (printing plate precursor) which can be used in the present invention will be described in greater detail below.

As the printing plate precursor there may be used a metal plate such as aluminum- or chromium-plated steel plate. In particular, an aluminum plate, which can be grained or anodized to have an excellent surface water retention and abrasion resistance, is desirable. As a more inexpensive printing plate precursor there may be used a printing plate precursor having a water-resistant support such as paper subjected to a water-resistant treatment, a plastic film or paper laminated with plastic, having provided thereon an image-receiving layer. The thickness of the printing plate precursor is preferably from 100 μm to 300 μm. The thickness of the image-receiving layer among that of the printing plate precursor is preferably in a range of from 5 to 30 μm.

The image-receiving layer includes a hydrophilic layer including an inorganic pigment and a binder and a layer capable of being rendered hydrophilic by an oil-desensitizing treatment.

The inorganic pigment used in the hydrophilic image-receiving layer include clay, silica, calcium carbonate, zinc oxide, aluminum oxide and barium sulfate. The binder used includes a hydrophilic binder, for example, polyvinyl alcohol, starch, carboxymethyl cellulose, hydroxyethyl cellulose, casein, gelatin, a salt of polyacrylic acid, polyvinyl pyrrolidone and a methyl ether-maleic anhydride copolymer. Further, in order to impart water-resistance to the image-receiving layer, a melamine formaldehyde resin, a urea formaldehyde resin or other crosslinking agents may be added thereto if desired.

The image-receiving layer to which an oil-desensitizing treatment is applied includes, for example, a layer containing zinc oxide and a hydrophobic binder.

The zinc oxide used in the image-receiving layer according to the present invention is any of zinc oxide, zinc white, wet-type zinc white, and activated zinc white as commercially available, as described in Nippon Ganryo Gijutsu Kyokai, ed., “Shinban Ganryo Binran (New Edition of Pigment Handbook)”, pp. 319, Kabushiki Kaisha Seiundo (1968).

Specifically, depending on the starting materials and production method, zinc oxide is classified into two groups, that produced by a wet method and that produced by a dry method, which groups are further subclassified into zinc oxide produced by the “French” method (indirect method) or “American” method (direct method). Suitable examples of zinc oxide include those commercially available from Seido Kagaku Kogyo K.K., Sakai Chemical Industry Co., Ltd., Hakusui Chemical Industries, Ltd., Honjo Chemical K.K., Toho Zinc Co., Ltd., and Mitsui Mining & Smelting Co., Ltd.

Specific examples of the resin to be used as binder include styrene copolymer, methacrylate copolymer, acrylate copolymer, vinyl acetate copolymer, polyvinyl butyral, alkyd resin, epoxy resin, epoxyester resin, polyester resin, and polyurethane resin. The resins may be employed singly or in combination of two or more thereof.

The content of the resin in the image-receiving layer is from 9/91 to 20/80 in terms of a weight ratio of resin/zinc oxide.

The oil desensitizing of zinc oxide is accomplished by the use of an oil-desensitizing solution. Examples of the oil-desensitizing solution which has heretofore been used for the oil-desensitizing of the image-receiving layer containing zinc oxide include those conventionally known, for example, a treating solution containing a cyan compound such as ferrocyanate or ferricyanate as the main component, a cyan-free treating solution containing an ammine cobalt complex, phytic acid or a derivative thereof, or a guanidine derivative as the main component, a treating solution containing an inorganic or organic acid capable of forming a chelate with an zinc ion as the main component, and a treating solution containing a water-soluble polymer.

For instance, treating solutions containing a cyan compound include those described, e.g., in JP-B-44-9045 (The term “JP-B” as used herein means an “examined Japanese patent application”), JP-B-46-39403, JP-A-52-76101, JP-A-57-107889 and JP-A-54-117201.

The surface of the printing plate precursor opposite the image-receiving layer preferably has a Beck smoothness of from 150 to 700 (sec/10 cc). In this arrangement, the printing plate thus formed can perform fair printing without causing sheer in printing or slippage on the plate cylinder.

For the measurement of Beck smoothness, a Beck smoothness testing machine can be used. In operation, the specimen is pressed against a circular glass plate having a hole formed at the center thereof which has been finished to a high degree of smoothness at a constant pressure of 1 kgf/cm² (9.8 N/cm²). Under these conditions, the time required until a predetermined amount (10 cc) of air passes through the gap between the surface of the glass plate and the specimen under reduced pressure is then measured.

The ink which can be used in the present invention is described in more detail below.

As the lipophilic component to be incorporated in the ink of the invention there is preferably used a hydrophobic resin or wax having a good affinity for the ink solvent. The hydrophobic resin may be used in the form of solution in the ink solvent or solid dispersion.

The hydrophobic resin, if used as a lipophilic component, has a weight-average molecular weight Mw of from 1×10² to 1×10⁶, preferably from 5×10² to 8×10⁵, more preferably from 1×10³ to 5×10⁵.

Specific examples of such a resin include olefin homopolyrners and copolymers (such as polyethylene, polypropylene, polyisobutylene, ethylene-vinyl acetate copolymer, ethylene-acrylate copolymer, ethylene-methacrylate copolymer and ethylene-methacrylic acid copolymer), vinyl chloride copolymers (such as polyvinyl chloride and vinyl chloride-vinyl acetate copolymer), vinylidene chloride copolymers, vinyl alkanoate homopolymers and copolymers, allyl alkanoate homopolymers and copolymers, homopolymers and copolymers of styrene and derivatives thereof (such as butadiene-styrene copolymer, isoprene-styrene copolymer, styrene-methacrylate copolymer and styrene-acrylate copolymer), acrylonitrile copolymers, methacrylonitrile copolymers, alkyl vinyl ether copolymers, acrylate homopolymers and copolymers, methacrylate homopolymers and copolymers, itaconic acid diester homopolymers and copolymers, maleic anhydride copolymers, acrylamide copolymers, methacrylamide copolymers, phenol resins, alkyd resins, polycarbonate resins, ketone resins, polyester resins, silicone resins, amide resins, hydroxyl and carboxyl-modified polyester resins, butyral resins, polyvinyl acetal resins, urethane resins, rosin resins, hydrogenated rosin resins, petroleum resins, hydrogenated petroleum resins, maleic acid resins, terpene resins, hydrogenated terpene resins, chroman-indene resins, cyclized rubber-methacrylate copolymers, cyclized rubber-acrylate copolymers, copolymers containing a heterocyclic ring containing no nitrogen atom (as the heterocyclic ring, e.g., furan ring, tetrahydrofuran ring, thiophene ring, dioxane ring, dioxofuran ring, lactone ring, benzofuran ring, benzothiophene ring and 1,3-dioxetane ring), and epoxy resins.

It is desirable for the resin particles to be contained in the ink of the invention in an amount of from 0.5 to 20% by weight based on the total ink content. If the amount of the resin particles is too low, the press life tends to decrease. On the other hand, if the proportion of resin particles is increased beyond the above-described range, it may be difficult to form a homogeneous dispersion, and, as a result, the ink clogs the recording head and stable ink ejection may not be achieved.

Examples of the wax to used as a lipophilic component include compounds to be used in solid ink jet recording process. For the details of these compounds, reference can be made to JP-A-2-69282, JP-A-5-186723. JP-A-6-206368, and U.S. Pat. Nos. 3,653,932, 3,715,219, 4,390,369, 4,484,948, 4,659,383, 4,684,956, 4,830,671, 4,889,560, 4,889,761, 4,992,304 and 5,084,099.

For the ink used in the present invention, it is preferred to include a coloring material as a colorant together with the lipophilic component in order to allow easy visual inspection of the resulting printing plate.

Such a coloring material may be any of a number of pigments and dyes which have been ordinarily used in conventional ink compositions and liquid developers for electrostatic photography.

The pigment to be used has no particular restriction, and includes both inorganic and organic pigments which are ordinarily used in the field of printing. Examples of pigments usable in the ink without any restriction include carbon black, cadmium red, molybdenum red, chrome yellow, cadmium yellow, titanium yellow, chromium oxide, viridian, titanium cobalt green, ultramarine blue, Prussian blue, cobalt blue, azo pigments, phthalocyanine pigments, quinacridone pigments, isoindolidone pigments, dioxazine pigments, threne pigments, perylene pigments, perylone pigments, thioindigo pigments, quinophthalone pigments, metal complex pigments, and other conventionally known pigments.

As the dyes, dyes are suitable for use in the ink, with examples including azo dyes, metal complex dyes, naphthol dyes, anthraquinone dyes, indigo dyes, carbonium dyes, quinoneimine dyes, xanthene dyes, cyanine dyes, quinoline dyes, nitro dyes, nitroso dyes, benzoquinone dyes, naphthoquinone dyes, phthalocyanine dyes and metallo-phthalocyanine dyes.

The pigments and dyes may be used singly, or they can be used in appropriate combinations. It is desirable that they are contained in a proportion of from 0.01 to 5% by weight based on the total ink content.

In the invention, there can be used an oil-based ink comprising resin particles which are solid and hydrophobic at least at ordinary temperatures (15° C. to 35° C.) dispersed in a nonaqueous solvent having an electrical resistance of 10⁹ Ω-cm or more and a dielectric constant of 3.5 or less. This oil-based ink can be used in an ink jet recording method involving ejection utilizing an electrostatic field to advantage.

Preferred examples of the nonaqueous solvent having an electrical resistance of 10⁹ Ω-cm or more and a dielectric constant of 3.5 or less include straight-chain or branched aliphatic hydrocarbons, alicyclic hydrocarbons, aromatic hydrocarbons and halogenated products of these hydrocarbons. Specific examples thereof include hexane, heptane, octane, isooctane, decane, isodecane, decaline, nonane, dodecane, isododecane, cyclohexane, cyclooctane, cyclodecane, benzene, toluene, xylene, mesitylene, Isopar C, Isopar E, Isopar G, Isopar H and Isopar L (Isopar: tradename, a product of Exxon Corp.), Shellsol 70 and Shellsol 71 (Shellsol; tradename, product of Shell Oil Corp.), Amsco OMS and Amsco 460 Solvent (Amusco: tradename, product of American Mineral Spirits Corp.), and silicone oils. They can be used singly or as a mixture of two or more thereof. As to the nonaqueous solvent, the upper limit of the electrical specific resistance value is of the order of 10¹⁶ Ω-cm, and the lower limit of the dielectric constant value is about 1.9.

The reason why the electrical specific resistance of the nonaqueous solvent to be used is defined as mentioned above is that when the electrical specific resistance of the nonaqueous solvent is lowered, the resin particles can hardly be high concentrated, deteriorating the press life. The reason why the dielectric constant of the nonaqueous solvent to be used is defined as mentioned above is that when the dielectric constant of the nonaqueous solvent is raised, the electrical field in the ink can be easily relaxed, preventing the resin particles from being highly concentrated and hence deteriorating the press life.

As the resin particles to be dispersed in the nonaqueous solvent as described above are hydrophobic resin particles which are solid at temperature of 35° C. or less and have good affinity with the nonaqueous solvent. As such a hydrophobic resin, a resin (P) having a glass transition temperature of from −5° C. to 110° C. or a softening temperature of from 33° C. to 140° C. is preferred. The more preferable range of the glass transition temperature is from 10° C. to 100° C., and that of the softening temperature is from 38° C. to 120° C. In particular, it is preferred for the resin (P) to have a glass transition temperature of from 15° C. to 80° C. or a softening temperature of from 380° C. to 100° C.

By using a resin having such a glass transition temperature or a softening temperature as described above, the affinity of each resin particle with the image-receiving surface of the printing plate precursor is enhanced and the resin particles are firmly bonded with each other on the printing plate precursor. Thus, the adhesion of the ink image to the printing plate precursor is increased and the press life is improved. On the contrary, if the glass transition temperature or a softening temperature of the resin used is beyond the upper and lower limits specified above, the affinity of each resin particle with the image-receiving surface of the printing plate precursor may be lowered and the bond between resin particles may be weakened.

The weight-average molecular weight (Mw) of the resin (P) is preferably from 1×10³ to 1×10⁶, more preferably from 5×10³ to 8×10⁵, and still more preferably from 1×10⁴ to 5×10⁵.

Specific examples of such a resin (P) can be selected from the group consisting of those described above with reference to the hydrophobic resin.

It is desirable for the resin particles to be contained in the oil-based ink of the invention in an amount of from 0.5 to 20% by weight based on the total ink content. If the amount of the resin particles is too low, the affinity of the ink with the image-receiving layer of the printing plate precursor is insufficient, and, as a result, the ink may not form images of good quality and the press life tends to decrease. On the other hand, if the proportion of resin particles is increased beyond the above-described range, it may be difficult to form a homogeneous dispersion, and, as a result, the ink flow through the ejection becomes uniform, making it difficult to achieve stable ink ejection.

For the oil-based ink used in the present invention, it is preferred to include a coloring material together with the resin particles in order to allow easy visual inspection of the resulting printing plate. The coloring material to be used and its amount are as defined above.

Such a coloring material as described above may be dispersed in the nonaqueous solvent as dispersed particles separately from the resin particles, or it may be incorporated into the resin particles dispersed in the nonaqueous solvent. In the latter case, the incorporation of a pigment is ordinarily effected by coating the pigment with the resin material of resin particles to form resin-coated particles, while the incorporation of a dye is ordinarily effected by coloring the surface portion of resin particles with the dye to form colored particles.

The average diameter of the resin particles, including colored particles, dispersed in the nonaqueous solvent is preferably from 0.05 to 5 μm, more preferably from 0.1 to 1.0 μm. The diameter of the particles is determined with a particle size analyzer, CAPA-500 (tradename, manufactured by Horida Ltd.).

The nonaqueous dispersion of resin particles used in the present invention can be prepared using a well-known mechanical grinding method or a polymerization granulation method. In the mechanical grinding method, the materials for forming resin particles are mixed, molten and kneaded, if required, and directly ground into fine particles with a conventional grinder, and further dispersed in the presence of a dispersing machine (e.g., a ball mill, a paint shaker, a Keddy mill, a Dyno mill). In another mechanical grinding method, the materials for forming resin particles and a dispersion assisting polymer (a covering polymer) are kneaded in advance to form a kneaded matter, then ground into fine particles, and further dispersed in the presence of a dispersing polymer. Methods of preparing paints or liquid developers for electrostatic photography can be adopted in practice. Details of these methods are described, e.g., in “Toryo no Ryudo to Ganryo Bunsan (Flow of Paints and Dispersion of Pigments)”, translated under the supervision of Kenji Ueki, Kyoritsu Shuppan (1971), Solomon, “Paint Science”, Hirokawa Shoten, 1969, “Paint and Surface Coating Theory and Practice”, Yuji Harasaki, “Coating no Kiso Kagaku (Elementary Course of Coating Science)”, Maki Shoten (1977), etc.

For the polymerization granulation method, well-known methods for dispersion polymerization in nonaqueous media can be employed. Details of such methods are described, e.g., in The Newest Technology of Super-Fine Polymer Particles, Chapter 2, edited under the supervision of Soichi Muroi, CMC Shuppan (1991), The Latest Systems for Electrophotographic Development, and Development and Application of Toner Materials, Chapter 3, edited by Koichi Nakamura, Nippon Kagaku Joho K. K. (1985), and K. B. J Barret, Dispersion Polymerization in Organic Medium, John Wiley (1975).

In order to stabilize the particles dispersed in the nonaqueous solvent, the particles are generally dispersed together with a dispersing polymer. The dispersing polymer contains repeating units soluble in the nonaqueous solvent as the main component, and a weight-average molecular weight (Mw) thereof is preferably from 1×10³ to 1×10⁶, more preferably from 5×10³ to 5×10⁵.

Suitable examples of the soluble repeating units of the dispersing polymer usable in the present invention include a component represented by the following formula (I):

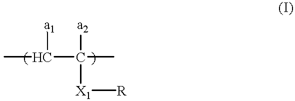

In the general formula (I), X₁ represents —COO—, —OCO— or —O—. R represents an alkyl or alkenyl group having from 10 to 32 carbon atoms, preferably an alkyl or alkenyl group having from 10 to 22 carbon atoms, which may have a straight-chain or branched structure and may be substituted, although the unsubstituted form is preferred.

Specific examples of the alkyl group include decyl, dodecyl, tridecyl, tetradecyl, hexadecyl, octadecyl, eicosanyl, docosanyl, decenyl, dodecenyl, tridecenyl, hexadecenyl, octadecenyl or linolenyl.

In the foregoing general formula (I), the suffixes a₁ and a₂, which may be the same or different, each represents a hydrogen atom, a halogen atom (e.g., chlorine or bromine), a cyano group, an alkyl group having from 1 to 3 carbon atoms (e.g., methyl, ethyl or propyl), —COO—Z₁ or —CH₂COO—Z₁ [wherein Z₁ represents a hydrocarbon group having not more than 22 carbon atoms which may be substituted (such as an alkyl, alkenyl, aralkyl, alicyclic or aryl group).

Preferred among the hydrocarbon groups represented by Z₁ are an unsubstituted or substituted alkyl group having from 1 to 22 carbon atoms (e.g., methyl, ethyl, propyl, butyl, hexyl, heptyl, octyl, nonyl, decyl, dodecyl, tridecyl, tetradecyl, hexadecyl, octadecyl, eicosanyl, docosanyl, 2-chloroethyl, 2-bromoethyl, 2-cyanoethyl, 2-methoxycarbonylethyl, 2-methoxyethyl or 3-bromopropyl), an unsubstituted or substituted alkenyl group having from 4 to 18 carbon atoms (e.g., 2-methyl-1-propenyl, 2-butenyl, 2-pentenyl, 3-methyl-2-pentenyl, 1-pentenyl, 1-hexenyl, 2-hexenyl, 4-methyl-2-hexenyl, decenyl, dodecenyl, tridecenyl, hexadecenyl, octadecenyl or linolenyl), an unsubstituted or substituted aralkyl group having from 7 to 12 carbon atoms (e.g., benzyl, phenetyl, 3-phenylpropyl, naphthylmethyl, 2-naphthylethyl, chlorobenzyl, bromobenzyl, methylbenzyl, ethylbenzyl, methoxybenzyl, dimethylbenzyl or dimethoxybenzyl), an unsubstituted or substituted alicyclic group having from 5 to 8 carbon atoms (e.g., cyclohexyl, 2-cyclohexylethyl or 2-cyclopentylethyl) and an unsubstituted or substituted aromatic group having from 6 to 12 carbon atoms (e.g., phenyl, naphthyl, tolyl, xylyl, propylphenyl, butylphenyl, octylphenyl, dodecylphenyl, methoxyphenyl, ethoxyphenyl, butoxyphenyl, decyloxyphenyl, chlorophenyl, dichlorophenyl, bromophenyl, cyanophenyl, acetylphenyl, methoxycarbonylphenyl, ethoxycarbonylphenyl, butoxycarbonylphenyl, acetamidophenyl, propionamidophenyl or dodecyloxylamidophenyl)].

In addition to the repeating units represented by formula (I), the dispersing polymer may contain other repeating units as copolymerizing components. The copolymerizing components may be derived from any monomers as long as they can be copolymerized with the monomers corresponding to the repeating units of formula (I).

The suitable proportion of the repeating unit represented by formula (I) in the dispersing polymer is preferably at least 50% by weight, more preferably at least 60% by weight.

Specific examples of the dispersing polymer include Dispersion Stabilizing Resin (Q-1) used in Examples described hereinafter and commercially available products, e.g., Sorprene 1205 manufactured by Asahi Chemical Industry Co., Ltd.

In preparing the resin (P) particles in the state of an emulsion (latex), it is preferred that the dispersing polymer be added prior to the polymerization.

The amount of the dispersing polymer to be added is from 0.05 to 4% by weight based on the total weight of the ink.

In such an oil-based ink, it is desirable that the dispersed resin particles and colored particles (or the particles of coloring material) be electroscopic particles charged positively or negatively.

In order to impart electroscopicity to those particles, wet developer technology for electrostatic photography can be appropriately utilized. Specifically, electroscopicity can be imparted to the particles by using a charge control agent and other additives as described, e.g., in “Saikin no Denshi Shashin Genzo System to Toner Zairyou no Kaihatsu Kitsuyouka (The Latest Systems for Electrophotographic Development, and Development and Application of Toner Materials)”, pp. 139-148, described above, “Denshi Shashin Gijutsu no Kiso to Oyo (The Fundamentals and Applications of Electrophotographic Techniques)”, edited by Electrophotographic Society, pp. 497-505, Corona Co. (1988), and Yuji Harasaki, “Denshi Shashin (Electrophotography)”, vol. 16 (No. 2), p. 44 (1977).

In addition, details of those materials are described, e.g., in British Patents 893,429, 934,038 and 1,122,397, U.S. Pat. Nos. 3,900,412 and 4,606,989, JP-A-60-179751, JP-A-60-185963 and JP-A-2-13965.

The charge control agent as described above is preferably used in an amount of from 0.001 to 1.0 parts by weight per 1,000 parts by weight of dispersing medium as a carrier liquid. Although, various kinds of additives can be further added, the total amount of additives has an upper limit because it is restricted by the electrical resistance allowable for the oil-based ink used in the present invention. More specifically, if the ink has an electrical resistance of lower than 10⁹ Ω-cm under the condition that the dispersed particles are removed from the ink, it is made difficult for the resin particles to be highly concentrated. Therefore, it is necessary that the amount of each additive added be controlled within the above described limitation.

The present invention will be illustrated in greater detail with reference to the following examples, but the invention should not be construed as being limited thereto.

### EXAMPLE 1

As an ink jet recording apparatus there was used an electrostatic multi-channel head disclosed in WO93/11866. In this ink jet recording process, an ink having a high resistivity comprising electrostatically chargeable resin particles which stay solid and hydrophobic at least at ordinary temperature dispersed in an insulating solvent is used. By allowing a strong electric field to act on the ink at the ejection position, agglomerates of the electrostatically chargeable resin particles are formed at the ejection position. Subsequently, the agglomerates are ejected from the election position by an electrostatic means.

As an ink jet recording head there was used a 61-channel multi-channel ink jet head (150 dots/25.4 mm) of the type shown in FIG. 9. FIG. 10 indicates the ink jet recording head of FIG. 9 from which ink regulating plates 42, 42′ are removed. A pump was used in this system An ink reservoir was provided in the ink inlet passage (I) between the pump and the recording head and between the ink recovering passage (O) of the recording head and the ink tank. The difference in hydrostatic pressure between the two ink reservoirs was used to circulate the ink. In order to control the temperature of the ink, heating by a heater was conducted in addition to stirring by the foregoing pump. The temperature of the ink was predetermined to be 35° C. In order to control the temperature of the ink, a thermostat was used. The recording resolution was predetermined to be 900 dots/25.4 mm both in the direction of main scanning and subsidiary scanning. The moving rate of the recording head in the direction of subsidiary scanning was predetermined to be 61 dots per rotation of the drum (per dot recorded in the direction of subsidiary scanning). Under these conditions, an image was recorded on the entire surface of the printing plate precursor. The circulatory pump was used also as a stirring member for preventing the precipitation and agglomeration. Provided in the ink passage was an optical density measuring instrument the output signal of which was then used to dilute the ink or add a concentrated ink to the ink, thereby performing concentration control.

An example of the process for the preparation of particulate hydrophobic resin (PL-1) to be incorporated in the ink will be described hereinafter.

Preparation of Resin Particle (PL-1)

A mixed solution of 10 g of Dispersion Stabilizing Resin (Q-1) having the structure illustrated below, 100 g of vinyl acetate, and 384 g of Isopar H was heated to a temperature of 70° C. under nitrogen gas stream with stirring. To the solution was added 0.8 g of 2,2′-azobis(isovaleronitrile) (abbreviated as A.I.V.N.) as a polymerization initiator, followed by reacting for three hours. Twenty minutes after the addition of the polymerization initiator, the reaction mixture became white turbid, and the reaction temperature rose to 88° C. Further, 0.5 g of the above-described polymerization initiator was added to the reaction mixture, and the reaction was carried out for two hours. Then, the temperature of the reaction mixture was raised to 100° C., and stirred for two hours to remove the unreacted vinyl acetate by distillation. After cooling, the reaction mixture was passed through a nylon cloth of 200-mesh to obtain a white dispersion. In the polymerization process, the percent polymerization was 90%. The white dispersion obtained was a latex of good monodispersity having an average particle diameter of 0.23 μm. The average particle diameter was measured by CAPA-500 (manufactured by Horiba Ltd.).

Dispersion Stabilizing Resin (Q-1)

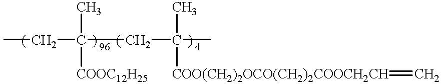

Mw: 5×10⁴ (ratio: by weight)

A portion of the above-described white dispersion was centrifuged at a rotation of 1×10⁴ r.p.m. for 60 minutes and the thus-precipitated resin particles were collected and dried. The weight-average molecular weight (Mw) of the resin particles was 2×10⁵ (a GPC value in terms of polystyrene) and the glass transition temperature (Tg) thereof was 38° C.

Preparation of Oil-based Ink (IK-1)

In a paint shaker (manufactured by Toyo Seiki K.K.), 10 g of copolymer of dodecyl methacrylate and acrylic acid (copolymerization ratio: 95/5 by weight), 10 g of nigrosine and 30 g of Shellsol 71 were placed together with glass beads, and the mixture was dispersed for four hours to prepare a fine dispersion of nigrosine.

A mixture of 60 g (as a solid basis) of Resin Particles (PL-1) prepared in Preparation Example 1, 2.5 g of the above-described dispersion of nigrosine, 15 g of FOC-1400 (tetradecyl alcohol, produced by Nissan Chemical Industries, Ltd.) and 0.08 g of copolymer of octene and semimaleic acid hexadecylamide was diluted with one liter of Isopar G, thereby preparing oil-based black ink.

An ink tank of an ink jet recording device of a computer-to-cylinder recording type lithographic printing apparatus (see FIG. 1) was filled with 2 liters of Oil-Based Ink (IK-1) thus prepared. An aluminum plate having a thickness of 0.12 mm which had been subjected to graining and anodizing treatment was used as a printing plate precursor. The printing plate precursor was mounted on the plate cylinder with the head and end thereof being gripped by a mechanical device provided on the plate cylinder. With the dampening water supplier, the printing ink supplier and the blanket cylinder being separated from the printing plate precursor, dust on the printing plate precursor surface was removed by air-pump suction. Then, the recording head was moved close to the printing plate precursor until it reached the recording position. Image data to be printed was transmitted to an arithmetic and control unit. While the 61-channel recording head was being carried at the same moving rate as the foregoing recording head (moved in the direction of subsidiary canning at a rate of 61 dots per rotation of the drum) by the rotation of the plate cylinder, the oil-based ink was ejected onto the aluminum printing plate precursor, thereby forming an image on the aluminum printing plate precursor. During ejection, the ejection electrode of the ejection head had a tip width of 10 μm, and the distance between the head and the printing plate precursor was kept at 1 mm by utilizing output from an optically gap-detecting device. A voltage of 2.5 kV was always applied as a bias voltage, and a pulse voltage of 500 V was further superimposed for each ejection of ink. The duration of pulse voltage was changed stepwise from 0.2 millisecond to 0.05 millisecond in 256 steps, thereby changing the dot area for recording. The image thus formed on the printing plate precursor had no defects due to dust, and deterioration of image quality due to a change in dot size was not observed at all even when the ambient temperature varied during the plate-making procedure and the number of printing plates prepared with the apparatus was increased. An image having a density as high as 6 times the channel density in the direction of subsidiary scanning of the recording head was obtained. In other words, satisfactory plate-making was accomplished.

The image formed on the printing plate precursor was hardened by heating over a heated roller (300 W halogen lamp-containing teflon seal silicone rubber roller) (at a pressure of 3 kg/cm²), thereby preparing a printing plate. Then, the ink jet recording device was moved away together with the subsidiary scanner from the position close to the plate cylinder and kept apart at a distance of 50 mm from the plate cylinder for the purpose of protecting the ejection head. Thereafter, printing was effected on printing paper using an ordinary lithographic printing method. In some detail, a printing ink and a dampening water were given to the printing plate to form a printing image thereon. The printing ink image thus formed was then transferred to the blanket cylinder rotating together with the plate cylinder. Subsequently, the printing ink image on the blanket cylinder was transferred to a printing coated paper passing through the gap between the blanket cylinder and the impression cylinder.

The print after printing 10,000 sheets had a very clear image without the occurrence of fading or sharpening of the printed image.

After the completion of plate-making, the ejection head was cleaned by supplying Isopar G to the head and dripping the Isopar G from the opening of the head for 10 minutes. Then, the head was stored in a cover filled with vapor of Isopar G. By this treatment, prints of good quality were provided for 3 months without any other work for maintenance.

### EXAMPLE 2

As an ink jet recording apparatus there was used the recording portion of a commercially available solid ink jet recording apparatus (Phaser 340J, produced by Sony Techtronics Co., Ltd.) Out of the 64 channels of recording head, 61 channels of ejection head were used according to equation defined in claim 1. As a printing plate precursor there was used an aluminum plate having a thickness of 0.12 mm which had been subjected to graining and anodizing treatment. Dust on the printing plate precursor surface was removed by air-pump suction. Then, the distance between the recording head which had been ready to eject the wax ink because the wax ink was molten and the printing plate precursor was controlled to be 2 mm by an output from an optical gap detector. Image data to be printed was transmitted to an image data arithmetic and control unit. While the plate cylinder was being rotated, the recording head was moved continuously at a constant rate and a subsidiary scanning speed of 61 dots/rotation with the resolution in the direction of subsidiary scanning being predetermined to be 10 times the resolution of the recording head, thereby ejecting an ink containing a lipophilic component onto the aluminum printing plate precursor to form an image. During ejection, error diffusion process with two values at 1200 dpi (dot/25.4 mm) from image data was employed to perform image recording.

The image thus formed on the printing plate precursor had no defects due to dust, and deterioration of image quality due to a change in dot size was not observed at all even when the ambient temperature varied during the plate-making procedure and the number of printing plates prepared with the apparatus was increased. In other words, satisfactory plate-making was accomplished.

Thereafter, printing was effected on printing coated paper using an ordinary lithographic printing method. In some detail, a printing ink and a dampening water were given to the printing plate to form a printing image thereon. The printing ink image thus formed was then transferred to the blanket cylinder rotating together with the plate cylinder. subsequently, the printing ink image on the blanket cylinder was transferred to a printing coated paper passing through the gap between the blanket cylinder and the impression cylinder.

The print after printing 10,000 sheets showed fading on some area of highlighted portion. However, the print up to 5,000 sheets had a very clear image without the occurrence of fading or sharpening of the printed image.

After the completion of plate-making, no particular maintenance was required. Thus, prints of good quality were provided even after 3 months or more.

### EXAMPLE 3

As an ink jet recording apparatus to be mounted on the four plate cylinders of a computer-to-cylinder recording type single-sided four-color lithographic printing apparatus (see FIG. 12) there was used a share mode 500-channel piezoelectric ink jet recording apparatus (XaarJet500S, produced by Xaar Co., Ltd.) according to the equation defined in claim 1. An ink containing a lipophilic component (produced by Xaar Co., Ltd.) or UV ink (produced by Xaar Co., Ltd.) was used For the adjustment of gap (0.8 mm), a contact roller made of teflon was used. The image data to be printed was transmitted to the image data arithmetic and control unit. The ink was ejected onto the aluminum printing plate mounted on the four plate cylinders at the same time. Thus, plate making was performed 500 times each for the ink and UV ink. The image recording was conducted with a resolution of 360 dots/25.4 mm. The size of dot was changed in eight stages to effect representation of gradation.

As a result, a printing plate having a good quality was obtained. The image thus formed on the printing plate precursor had no defects due to dust, and no effects of variation of the ambient temperature were observed. With the increase of the number of sheets of printing plates thus made, there was shown some change in dot size which has no effect on the image quality.

The printing plate made with UV ink was hardened by irradiation with light beam from a UV lamp (Type UL2-350USP low pressure mercury vapor lamp, produced by USHIO INC.). As a result, the full-color print obtained had a very clear image without the occurrence of fading or sharpening of image even after printing 5,000 sheets. In particular, when UV ink was used, the full-color print obtained had a very clear image without the occurrence of fading or sharpening of image even after printing 20,000 sheets.

After the termination of plate making, the ejection portion of the head was wiped with a nonwoven fabric and then housed in the cover. In this manner, prints having a good image quality were provided for 3 months without any maintenance.

### EXAMPLE 4

As an ink jet recording apparatus there was used the recording portion of a piezoelectric ink jet recording apparatus (Colorio PM750C, produced by Seiko Epson Inc.) according to the equation defined in claim 1. The same as used in Example 3 was used. As a printing plate precursor there was used a paper printing plate precursor comprising a hydrophilic image-receiving layer provided on the surface thereof.

High-quality paper having a basis weight of 100 g/m² was used as a substrate and, on both sides of the substrate, a water-resistant layer comprising as main ingredients kaolin and resin components, including polyvinyl alcohol, SBR latex and melamine resin, was provided to form a paper support. A dispersion A prepared from the following composition in the following manner was applied to the paper support in a dry coating amount of 6 g/m² to form an image-receiving layer, thereby preparing a paper printing plate precursor.

Dispersion A

| | | |
|---|---|---|
| Gelatin (1st grade, produced by | 3 | g |
| Wako Pure Chemical Industries, Ltd.) | | |
| Colloidal silica (Snowtex C; produced | 20 | g |
| by Nissan Chemical Industries, Ltd.; 20% | | |
| aqueous solution) | | |
| Silica gel (Silysya #310, produced by | 7 | g |
| Fuji Silysya Chemical Co., Ltd.) | | |
| Hardener (paraformaldehyde) | 0.4 | g |
| Distilled water | 100 | g |

The foregoing ingredients were subjected to dispersion together with glass beads in a paint shaker for 10 minutes.

The recording head was mounted on a single-sided monochromatic printing apparatus (see FIG. 1). For the adjustment of gap (0.8 mm), a contact roller made of teflon was used. The image data to be printed was transmitted to the image data arithmetic and control unit. While the plate cylinder was being rotated, the ejection head was moved according to the equation defined in the claim using a 31-channel multi-channel ink jet head for one color, whereby the ink was ejected onto the printing plate precursor on the plate cylinder to form an image thereon. Thus, a printing plate was made. The image recording was conducted with a resolution of 720 dots/25.4 mm. An error diffusion process was employed to effect representation of gradation.

The circulatory pump was used also as a stirring member for preventing the precipitation and agglomeration. Provided in the ink passage was an optical density measuring instrument the output signal of which was then used to dilute the ink or add a concentrated ink to the ink, thereby performing concentration control.

As a result, a printing plate having a good quality was obtained. The image thus formed on the printing plate precursor had no defects due to dust, and no effects of variation of the ambient temperature were observed. Printing was made on a printing coated paper. As a result, the print after printing 5,000 sheets had a very clear image without the occurrence of fading or sharpening of the printed image. However, the print after printing 5,000 sheets showed a longitudinal elongation of 0.1 mm on A3 size image.

On the other hand, as a printing paper there was used high-quality paper. During the printing of 3,000th sheet, the image was made solid on some area due to paper dust. Then, an air suction pump was installed as a paper dust generation inhibiting device in the vicinity of the paper supplier. Then, printing was resumed.

As a result, no defectives in printing occurred, The print after printing 5,000 sheets had a very clear image without the occurrence of fading or sharpening of the printed image. However, the print after printing 5,000 sheets showed a longitudinal elongation of 0.1 mm on A3 size image.

After the termination of plate making, the head nozzle was cleaned by suction and then housed in the cover. In this manner, prints having a good image quality were provided for 3 months without any maintenance.

### EXAMPLE 5

The same procedure as in Example 1 was performed, except that the aluminum printing plate precursor was replaced with a printing plate precursor provided with an image-receiving layer capable of being rendered hydrophilic upon an oil-desensitizing treatment described below. As a recording head there was used a 61-channel multi-channel ink jet head having 150 dots/25.4 mm. The recording resolution was predetermined to be 900 dots/25.4 mm both in the direction of main scanning and subsidiary scanning. The moving rate of the recording head in the direction of subsidiary scanning was predetermined to be 61 dots per rotation of the drum (per dot recorded in the direction of subsidiary scanning). Under these conditions, an image was recorded on the entire surface of the printing plate precursor.

The procedure of Example 1 was followed except that the non-image area of the printing plate prepared was rendered hydrophilic using a plate surface oil-desensitizing device, the conductive layer of the printing plate precursor was grounded by contact with a conductive leaf spring (made of phosphor bronze) during the recording operation, and fixing was carried out by exposing the printing plate precursor to hot air.

High-quality paper having a basis weight of 100 g/m² was used as a substrate and, on both sides of the substrate, a polyethylene film was laminated in a thickness of 20 μm to form a water-resistant paper support. On one side of the thus-prepared paper support, a coating for conductive layer having the following composition was coated in a dry coating amount of 10 g/m² to form a conductive layer and further thereon Dispersion B prepared in the manner indicated below was coated in a dry coating amount of 15 g/m² to form an image-receiving layer, thereby preparing a printing plate precursor.

(1) Coating for Conductive Layer:

A coating was prepared by mixing 5.4 parts of carbon black (30% aqueous dispersion), 54.6 parts of clay (50% aqueous dispersion), 36 parts of SBR latex (solid content: 50%, Tg; 25° C.) and 4 parts of melamine resin (solid content: 80%, Sumirez Resin SR-13), and then adding water thereto so as to have the total solid content of 25%.

(2) Dispersion B:

A mixture of 100 g of dry-type zinc oxide, 3 g of Binder Resin (B-1) having the structure shown below, 17 g of Binder Resin (B-2) having the structure shown below, 0.15 g of benzoic acid and 155 g of toluene was dispersed using a wet-type dispersing machine (Homogenizer made by Nippon Seiki Co., Ltd.) at 6,000 r.p.m. for 8 minutes.

Binder Resin (B-1)

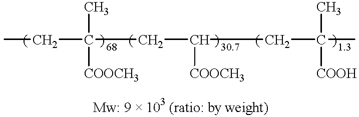

Binder Resin (B-2)

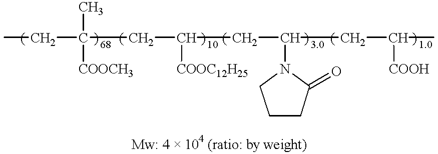

As a result, an image having a density as high as 6 times the channel density in the direction of subsidiary scanning of the recording head was obtained. The image thus formed on the printing plate precursor had no defects due to dust, and no effects of variation of the ambient temperature were observed.

### EXAMPLE 6

As an ink jet recording apparatus there was used a thermal jet apparatus (BJ35V, produced by CANON INC.). The recording portion of a 73-channel recording head having 100 dots/25.4 mm was used. As an ink there was one prepared according to the following formulation.

| | |
|---|---|
| acrylic resin (DEGALANLS 50/150, | 5% by weight |
| produced by Dagussa Inc.) | |
| Dye (victoria pure blue produced by | 30% by weight |
| Hodogaya Chemical Co., Ltd.) | |
| Methyl ethyl ketone | 55% by weight |
| Ethylene glycol monoethyl ether | 10% by weight |

The same printing plate precursor as used in Example 5 was mounted on the plate cylinder, Dust on the surface of the printing plate precursor was removed by suction by an air pump. The distance between the recording head and the printing plate precursor was controlled to be 2 mm by utilizing output from an optically gap-detecting device. The image data to be printed was transmitted to the image data arithmetic and control unit. The recording resolution was predetermined to be 600 dots/25.4 mm both in the direction of main scanning and subsidiary scanning. The moving rate of the recording head in the direction of subsidiary scanning was predetermined to be 73 dots per rotation of the drum (per dot recorded in the direction of subsidiary scanning). Under these conditions, an image was recorded on the entire surface of the printing plate precursor.

As a result, an image having a density as high as 6 times the channel density in the direction of subsidiary scanning of the recording head was obtained. Thus, a printing plate having a good image quality was prepared. The image thus formed on the printing plate precursor had no defects due to dust, and no effects of variation of the ambient temperature were observed.

Thereafter, printing was made on a printing paper in the same manner as previously mentioned. The print after printing 10,000 sheets showed fading on some area of highlighted portion. However, the print up to 5,000 sheets had a very clear image without the occurrence of fading or sharpening of the printed image.

After the completion of plate-making, the head nozzle was cleaned by suction and wiping with a nowoven fabric, and then housed in a cover. In this manner, prints of good quality were provided without any maintenance even after 3 months or more.

### EXAMPLE 7

An ink tank of an ink jet recording device of a press recording type lithographic printing apparatus (see FIG. 1) was filled with 2 liters of the foregoing Oil-Based Ink (IK-1). A 150 (dots/25.4 mm) 61-channel multiple-channel head as shown in FIG. 5 was used as an ejection head. A Peltie element was provided so as to keep the head temperature to 30° C. The resolution in recorded image was 900 (dots/25.4 mm) both in the direction of main scanning and subsidiary scanning. The moving speed of the ejection head in the direction of subsidiary scanning was predetermined to be 61 dots per rotation of drum (per dot recorded in the direction of subsidiary scanning). In this arrangement, image was recorded all over the surface of the plate material. A drop-in type heater and stirring blades were installed for controlling the ink temperature in the ink tank. The ink temperature was set at 30° C., and temperature control was carried out with a thermostat while rotating the stirring blades at 30 r.p.m. Rotation of the stirring blades was also utilized for preventing precipitation and aggregation.

Further, a portion of the ink flow course was made transparent, which portion was arranged between a light emission diode (LED) and a light detector, concentration control of the ink was carried out by feeding diluent for the ink (Isoper G) or concentrated ink (the solid concentration of which was adjusted to twice that of Oil-Based Ink (IK-1)).

An aluminum plate having a thickness of 0.12 mm which had been subjected to graining and anodizing treatment was used as a printing plate precursor. The printing plate precursor was mounted on the plate cylinder with the head and end thereof being gripped by a mechanical device provided on the plate cylinder. With the dampening water supplier, the printing ink supplier and the blanket cylinder being separated from the printing plate precursor, dust on the printing plate precursor surface was removed by air-pump suction. Then, the ejection head was moved close to the printing plate precursor until it reached the recording position. Image data to be printed was transmitted to an arithmetic and control unit. The oil-based ink was ejected onto the aluminum printing plate precursor, thereby forming an image on the aluminum printing plate precursor.

During ejection, the ejection electrode of the ejection head had a tip width of 10 μm, and the distance between the head and the printing plate precursor was kept at 1 mm by utilizing output from an optically gap-detecting device. A voltage of 2.5 kV was always applied as a bias voltage, and a pulse voltage of 500 V was further superimposed for each ejection of ink. The duration of pulse voltage was changed stepwise from 0.2 millisecond to 0.05 millisecond in 256 steps, thereby changing the dot area for recording. As a result, a high precision in hitting was accomplished to effect recording of high quality image. Further, the image thus formed on the printing plate precursor had no defects due to dust, and deterioration of image quality due to a change in dot size was not observed at all even when the ambient temperature varied during the plate-making procedure and the number of printing plates prepared with the apparatus was increased. In other words, satisfactory plate-making was accomplished.

The image formed on the printing plate precursor was hardened by heating with a xenon flash fixing device (made by USHIO INC.) under a luminous intensity of 200 J/pulse, thereby preparing a printing plate. Then, the ink jet recording device was moved away together with the subsidiary scanner from the position close to the plate cylinder and kept apart at a distance of 50 mm from the plate cylinder for the purpose of protecting the ejection head. Thereafter, printing was effected on printing paper using an ordinary lithographic printing method. In some detail, a printing ink and a dampening water were given to the printing plate to form a printing image thereon. The printing ink image thus formed was then transferred to the blanket cylinder rotating together with the plate cylinder. Subsequently, the printing ink image on the blanket cylinder was transferred to a printing coated paper passing through the gap between the blanket cylinder and the impression cylinder.

The print after printing 10,000 sheets had a very clear image without the occurrence of fading or sharpening of the printed image.

After the completion of plate-making, the ejection head was cleaned by supplying Isopar G to the head and dripping the Isopar G from the opening of the head for 10 minutes. Then, the head was stored in a cover filled with vapor of Isopar G. By this treatment, prints of good quality were provided for 3 months without any other work for maintenance.

### EXAMPLE 8

As a stirring member there was used a circulating pump. A 50 (dots/25.4 mm) 73-channel multiple head of the type shown in FIG. 7 was installed. A heater and a thermostat were provided so as to keep the head temperature to 35° C. The resolution in recorded image was 1,800 (dots/25.4 mm) in the direction of main scanning and 1,200 (dots/25.4 mm) in the direction of subsidiary scanning The moving speed of the ejection head in the direction of subsidiary scanning was predetermined to be 73 dots per rotation of plate cylinder (per dot recorded in the direction of subsidiary scanning) In this arrangement, image was recorded all over the surface of the plate material. The pump was used in the present example. One ink reservoir was arranged between the pump and the ink flow-in course of the ejection head, and another ink reservoir was arranged between the ink recovery course of the ejection head and the ink tank. The ink was circulated by the difference in hydrostatic pressure between those reservoirs in addition to the action of the circulatory pump. Also, a combination of the circulatory pump with a heater was used for controlling the ink temperature, and the ink temperature was set at 35° C. and controlled with a thermostat.

The circulatory pump was further used as stirrer for preventing precipitation and aggregation. The ink flow course was provided with a conductance measuring device, and according to output signals from the device, concentration control of the ink was carried out by diluting the ink or feeding concentrated ink. The same aluminum plate as described above was used as a printing plate precursor, and fixed to the plate cylinder of the lithographic printing apparatus in the same manner as described above. Dust on the surface of the printing plate precursor was removed with a rotating brush made of nylon. Then, the image data to be printed was transmitted to an arithmetic and control unit. Image forming was carried out by ejecting the oil-based ink from the full-line head onto the aluminum printing plate precursor while rotating the plate cylinder, thereby forming an image thereon. As a result, a high precision in hitting was accomplished to effect recording of high quality image. Thus, an image having a density as high as 36 times the channel density in the direction of subsidiary scanning of the ejection head was obtained. The image thus formed on the printing plate precursor had no defects due to dust, and deterioration of image quality due to a change in dot size was not observed at all even when the ambient temperature varied during the plate-making procedure and the number of printing plates prepared with the apparatus was increased. In other words, satisfactory plate-making was accomplished. Subsequently, the image was subjected to heat roll fixing (produced by Hitachi Metals, Ltd.; power consumption: 1.2 kW) to solidify, thereby making a printing plate.

Using the printing plate thus made, printing was then conducted. As a result, the print obtained had a very clear image without the occurrence of fading or sharpening of image even after printing 10,000 sheets. After the completion of plate-making, Isopar G was circulated through the ejection head. A nonwoven fabric impregnated with Isopar G was then brought into contact with the tip of the head to clean the head. By this treatment, prints of good quality were provided for 3 months without any other work for maintenance.

The foregoing procedure was followed except that the ink jet head of the type shown in FIG. 7 was replaced by a 73-channel multi-head having 50 dots/25.4 mm of the type shown in FIGS. 9 and 11. As a result, good results were obtained similarly to the foregoing case.

### EXAMPLE 9

A 100 (dots/25.4 mm) 73-channel multiple channel head as shown in FIG. 9 was mounted as an ejection head on the ink jet recording device of a press recording type four-color lithographic printing apparatus (see FIG. 12). Using a contact roller made of Teflon, the gap was adjusted to 0.8 mm. The resolution in recorded image was 600 (dots/25.4 mm) both in the direction of main scanning and subsidiary scanning. The duration of pulse voltage was changed stepwise from 90 microsecond to 190 microsecond in 16 steps, thereby changing the dot area for recording. The moving speed of the ejection head in the direction of subsidiary scanning was predetermined to be 73 dots per rotation of drum (per dot recorded in the direction of subsidiary scanning). In this arrangement, image was recorded all over the surface of the plate material. 5,000 sheets of printing plates were then prepared in the same manner as in Example 1 except that the ink tank was replenished with a concentrated ink according to the number of sheets having image recorded thereon to control the ink concentration.

As a result, a high precision in hitting was realized to effect recording of high quality image. An image having a density as high as 6 times the channel density in the direction of subsidiary scanning of the recording head was obtained. The image thus formed on the printing plate precursor showed no defects due to dust and was not affected by the change of the ambient temperature. Further, there was generated no odor from the ink solvent. As the number of sheets of printing plates made increased, the diameter of dots printed showed some but an acceptable change. The printing plates thus made were also subjected to flash fixing as mentioned above and fixing by irradiation with light from a halogen lamp (Type QIR, produced by USHIO INC.), or fixing with spray of ethyl acetate.

For the fixing by irradiation with a halogen lamp, heating was effected so that the temperature of the surface of the printing plate reached 95° C. for 20 seconds. For the fixing with spray of ethyl acetate, the amount of ethyl acetate sprayed was adjusted to about 1 g/m² As a result, the print after printing 10,000 sheets had a very clear full-color image without the occurrence of fading or sharpening of the printed image. In particular, the fixing time in heat roll fixing or fixing by irradiation with light from a halogen lamp was drastically reduced by wrapping a heat insulating material (PET film) around the plate cylinder. In this case, the aluminum substrate was grounded through an electrically-conductive brush (Thunderlon, produced by Tuchiya K.K.; resistance: about 10⁻¹ Ω-cm) which comes in contact therewith.

### EXAMPLE 10

The procedure of Example 7 was followed except that the aluminum printing plate precursor of Example 7 was replaced by a paper printing plate precursor comprising the hydrophilic image-receiving layer provided on the surface thereof described in Example 4.

On the other hand, printing plates were prepared in the same manner as in Example 1 except that as the printing paper there was used high-quality paper. During the printing of 3,000th sheet, the image was made solid on some area due to paper dust. Then, an air suction pump was installed as a paper dust generation inhibiting device in the vicinity of the paper supplier. Then, printing was resumed. As a result, no detectives in printing occurred. The print after printing 5,000 sheets had a very clear image without the occurrence of fading or sharpening of the printed image. However, the print after printing 5,000 sheets showed a longitudinal elongation of 0.1 mm on A3 size image.

### EXAMPLE 11

The same procedure as in Example 1 was performed, except that the printing plate precursor was replaced with the printing plate precursor provided with an image-receiving layer capable of being rendered hydrophilic upon an oil-desensitizing treatment described in Example 5, the non-image area of the printing plate prepared was rendered hydrophilic using a plate surface oil-desensitizing device, the conductive layer of the printing plate precursor was grounded by contact with a conductive leaf spring (made of phosphor bronze) during the recording operation, and fixing was carried out by exposing the printing plate precursor to hot air.

The print after printing 5,000 sheets had a very clear image without the occurrence of fading or sharpening of the printed image.

According to the present invention, in order to perform image recording by an ink jet recording process involving the ejection of an ink containing a hydrophilic component through an ejection head having a plurality of ejection channels, image recording is carried out by performing main scanning while rotating the plate cylinder having a printing plate precursor mounted thereon and subsidiary scanning while moving the ejection head at a constant velocity in the direction parallel to the axis of the plate cylinder, making it possible to provide a large number of prints having clear images even without using an expensive controller. Further, a printing plate of high image quality is directly formed on the press corresponding to digital image data in a stable manner, making it possible to conduct lithographic printing at a low cost and a high speed.

While the invention has been described in detail and with reference to specific embodiments thereof, it will be apparent to one skilled in the art that various changes and modifications can be made therein without departing from the spirit and scope thereof.

What is claimed is:

1. A computer-to-cylinder recording type lithographic printing method comprising:
mounting a printing plate precursor onto a plate cylinder;
forming an image directly onto a surface of said printing plate precursor mounted on the plate cylinder, by an ink jet process which comprises ejecting an ink containing a lipophilic component onto said printing plate precursor surface from a recording head having a plurality of ejection channels according to signals of image data, to thereby prepare a printing plate, said image recording being carried out while rotating the plate cylinder to effect main scanning, and moving said recording head in a direction parallel to an axis of the plate cylinder to effect subsidiary scanning; and
performing lithographic printing with said printing plate,
wherein the number of the ejection channels of said recording head to be used for the image formation is (X·(N/K)+1), wherein N (dots/25.4 mm) represents an image recording resolution on the printing plate precursor in a direction perpendicular to the rotation of said plate cylinder; K (dots/25.4 mm) represents the density of channels in the ejection head in the direction perpendicular to the rotation of said plate cylinder; and X represents an arbitrary positive integer, and
wherein the subsidiary scanning movement of said ejection head is carried out continuously at a constant speed of (X·(N/K)+1) (dot/rotation).

2. The computer-to-cylinder recording type lithographic printing method according to claim 1, further comprising removing dust present on the surface of said printing plate precursor at least one of before and during said image recording.

3. The computer-to-cylinder recording type lithographic printing method according to claim 1, further comprising cleaning said recording head at least after the termination of the printing plate preparation.

4. The computer-to-cylinder recording type lithographic printing method according to claim 1, wherein said ejection of the ink from said recording head is carried out utilizing an electrostatic field.

5. The computer-to-cylinder recording type lithographic printing method according to claim 4, wherein said ink comprises:
a nonaqueous solvent having an electrical specific resistance of 10⁹ Ω-cm or more and a dielectric constant of 3.5 or less; and
resin particles dispersed therein, which are solid and hydrophobic at least at ordinary temperature.

6. A computer-to-cylinder recording type lithographic printing apparatus comprising:
a plate cylinder for mounting a printing plate precursor thereon;
an image forming unit comprising an ink jet recording device including a recording head having a plurality of ejection channels, which ink jet recording device forms an image by ejecting an ink containing a lipophilic component from said recording head directly onto a surface of the printing plate precursor mounted on said plate cylinder according to signals of image data utilizing an electrostatic field to prepare a printing plate; and
a lithographic printing unit which performs lithographic printing with the printing plate formed by said image forming unit,
wherein said image forming unit performs main scanning by rotating said plate cylinder mounting the printing plate precursor thereon and performs subsidiary scanning by moving said recording head in a direction parallel to an axis of the plate cylinder,
wherein the number of the ejection channels of said recording head to be used for the image formation is (X·(N/K)+1), wherein N (dots/25.4 mm) represents an image recording resolution on the printing plate precursor in a direction perpendicular to the rotation of said plate cylinder; K (dots/25.4 mm) represents the density of channels in the ejection head in the direction perpendicular to the rotation of said plate cylinder; and X represents an arbitrary positive integer, and wherein the subsidiary scanning movement of said ejection head is carried out continuously at a constant speed of (X·(N/K)+1) (dot/rotation).

7. The computer-to-cylinder recording type lithographic printing apparatus according to claim 6, wherein said image forming unit further comprises a dust removing member which removes dust present on the surface of the printing plate precursor at least one of before and during the image recording.

8. The computer-to-cylinder recording type lithographic printing apparatus according to claim 6, wherein said ink jet recording device further comprises a recording head moving member which moves said recording head close to said plate cylinder during the image recording and moving said recording head away from said plate cylinder except during the image recording.

9. The computer-to-cylinder recording type lithographic printing apparatus according to claim 6, wherein said image forming unit further comprises a recording head cleaning member which cleans the recording head at least after the termination of the printing plate preparation.

10. The computer-to-cylinder recording type lithographic printing apparatus according to claim 6, wherein said lithographic printing unit further comprises a paper dust removing member which removes paper dust during the lithographic printing.

11. The computer-to-cylinder recording type lithographic printing apparatus according to claim 6, wherein said ink jet recording device further comprises means for ejecting the ink from said recording head utilizing an electrostatic field.

12. The computer-to-cylinder recording type lithographic printing apparatus according to claim 11, wherein said ink comprises:
a nonaqueous solvent having an electrical specific resistance of 10⁹ Ω-cm or more and a dielectric constant of 3.5 or less; and
resin particles dispersed therein, which are solid and hydrophobic at least at ordinary temperature.

13. The computer-to-cylinder recording type lithographic printing apparatus according to claim 6, wherein said image forming unit further comprises an ink-fixing unit.

14. The computer-to-cylinder recording type lithographic printing apparatus according to claim 6, wherein said ink et recording device further comprises an ink supplying member which supplies the ink to said recording head.

15. The computer-to-cylinder recording type lithographic printing apparatus according to claim 14, wherein said ink jet recording device further comprises an ink-recovering member which recovers the ink from the recording head to circulate the ink together with said ink-supplying member.

16. The computer-to-cylinder recording type lithographic printing apparatus according to claim 14, wherein said ink jet recording device further comprises an ink tank for storing the ink and an ink stirring member which stirs the ink in said ink tank.

17. The computer-to-cylinder recording type lithographic printing apparatus according to claim 6, wherein said ink jet recording device further comprises an ink tank for storing the ink and an ink temperature controlling member provided in said ink tank.

18. The computer-to-cylinder recording type lithographic printing apparatus according to claim 6, wherein said ink jet recording device further comprises an ink concentration controlling member which controls a concentration of the ink.

19. The computer-to-cylinder recording type lithographic printing apparatus according to claim 6, wherein said image forming unit further comprises a recording head temperature controlling member which controls a temperature of said recording head.
